(19) United States
(12) Patent Application Publication
(10) Pub. No.: US 2025/0321786 A1
(43) Pub. Date: Oct. 16, 2025

(54) MODULAR EXTENSIBLE FRAMEWORK EVENT-BASED TASK SCHEDULING

(71) Applicant: NVIDIA Corporation, Santa Clara, CA (US)

(72) Inventors: Chandrahas Jagadish Ramalad, Santa Clara, CA (US); Prashant Gaikwad, Cupertino, CA (US); Piyush Shekdar, Pune (IN); Beixing Yin, San Jose, CA (US)

(21) Appl. No.: 19/063,698

(22) Filed: Feb. 26, 2025

Related U.S. Application Data
(60) Provisional application No. 63/633,848, filed on Apr. 14, 2024.

(51) Int. Cl. G06F 9/48

(52) U.S. Cl. CPC G06F 9/4881

(57) ABSTRACT

Disclosed are apparatuses, systems, and methods for software-agnostic retrievals of event-based task scheduling. The systems and methods utilize a dispatcher to monitor events within the system to provide the scheduler with nodes ready for execution. Using an indicator, the system can determine, that the first node assigned to a first phase of a task is in a first state of a plurality of states. Based on the first state, the identifier can be added to a queue. A second phase of the task can be determined to be in a second state, the first identifier may be provided to a scheduler to advance the task to the second phase.

### RELATED APPLICATIONS

This application claims the benefit of U.S. Patent Application No. 63/633,848, filed Apr. 14, 2024, the entire contents of which are incorporated herein by reference.

### TECHNICAL FIELD

At least one embodiment pertains to monitoring performance of processing resources running computational applications. For example, at least one embodiment pertains to monitoring performance of multi-processing computing devices that run computational applications.

### BACKGROUND

A modular extensible framework can be an architecture that allows for the creation of systems that enable task execution. The modular extensible framework can include pre-defined components and modules of an artificial intelligence (AI) system that can be arranged in a design for an AI computational purpose. The components and modules can be, in some examples, nodes (e.g., neural network nodes) used to execute tasks (e.g., AI-related tasks). For task execution systems, a scheduler can be utilized to assign tasks to the nodes.

### BRIEF DESCRIPTION OF DRAWINGS

FIG. 1 is a schematic block diagram of an example system architecture providing extensible modular framework event-based task scheduling, according to at least one embodiment;

FIG. 2 illustrates an example data flow between the nodes, scheduler, dispatcher, and data queue of FIG. 1, according to at least one embodiment;

FIG. 3 illustrates example logic flow between a dispatcher and a node of FIG. 1, according to at least one embodiment;

FIG. 4 illustrates an example logic flow of phases of a node operating with a time delay condition, according to at least one embodiment;

FIG. 5 illustrates an example logic flow of phases of a node operating with count condition, according to at least one embodiment;

FIG. 6 illustrates an example logic flow of phases of a node operating with a target time condition, according to at least one embodiment;

FIG. 7 illustrates an example logic flow of phases of a node operating based on external events, according to at least one embodiment;

FIG. 8 is a flow diagram of an example method of event-based task scheduling for a module extensible framework, according to at least one embodiment;

FIG. 9A illustrates inference and/or training logic, according to at least one embodiment;

FIG. 9B illustrates inference and/or training logic, according to at least one embodiment;

FIG. 10 illustrates training and deployment of a neural network, according to at least one embodiment;

FIG. 11 is an example data flow diagram for an advanced computing pipeline, according to at least one embodiment;

FIG. 12 is a system diagram for an example system for training, adapting, instantiating and deploying machine learning models in an advanced computing pipeline, according to at least one embodiment;

FIG. 13A is a block diagram of an example generative language model system suitable for use in implementing at least some embodiments of the present disclosure;

FIG. 13B is a block diagram of an example embodiment in which the generative LM includes a transformer encoder-decoder, according to at least one embodiment;

FIG. 13C is a block diagram of an example embodiment in which the generative LM includes a decoder-only transformer architecture, according to at least one embodiment; and

FIG. 14 is a block diagram of an example computing device suitable for use in implementing some embodiments of the present disclosure.

### DETAILED DESCRIPTION

The present disclosure is directed to event based task scheduling for modular extensible frameworks. To schedule tasks on the nodes, previous solutions have relied on greedy and thread-poll multi-thread schedulers. Greedy and thread-poll multi-thread schedulers use continuous polling to determine the state of each node and the state of each task on each node. Nodes may process a task sequentially, such that a task is processed by a first node associated with a first type before being passed to, and processed by, a second node associated with a second type. Upon determining the second node is ready to receive a task to execute, and determining the task on the first node is processed and ready to be provided to the second node, the scheduler directs the task from the first node to the second node. For example, a task may be processed by an input node, an inference node, and a sink node, in that order. An input node may be responsible for receiving and pre-processing raw data that will be passed into the neural network for processing. An inference node may execute the core computation of the neural network to make predictions or generate outputs based on the input data. A sink node may be responsible for collecting, storing and/or further processing the results from the inference node. A system may have multiple of each node type. After a first task has been executed on an input node, it can be transferred to an inference node. In traditional systems, the scheduler of the system may continually check all nodes for task execution status and availability to accept a task according to a predefined order. The scheduler will only learn of a change in node status for a node when that node is checked, such that the scheduler may check the status of all other nodes before learning that the node has completed execution of a task. Subsequently, the scheduler may determine the availability of an inference node to accept the completed task. Again, the scheduler can identify the availability of a second node only after learning of a completed execution task and then it may check all nodes in the pre-defined order until the scheduler identifies a second node that is available for task assignment. Thus, traditional scheduler implementations are inefficient because they rely on on-completion task scheduling and consume significant computational resources by continually checking node status.

Aspects of the present disclosure address the above and other deficiencies of conventional task scheduling techniques by providing event-based task scheduling that improves scheduling of tasks between nodes of a modular extensible framework designed for a computational purpose. Event-based task scheduling can include the use of a dispatcher that monitors nodes based on events, rather than a continual node status checks. Events can include completion of task processing, task assignment availability, and/or other conditions.

To provide the scheduler with node availability, the dispatcher can, in some embodiments, receive flag indications from nodes and/or monitor node flags. For example, an input node may complete task execution of a task that should be subsequently provided to an inference node for additional processing. Rather than waiting for the scheduler to identify that the task is complete based on ordered checking, the input node may raise a flag or provide a notification to the dispatcher to indicate that task processing is complete or is about to be complete. The dispatcher may then indicate to the scheduler that the task is ready to be moved to a next node in the process.

The dispatcher may also receive an indication of a flag state change from one or more inference nodes. For example, when a node enters an execution state, the node may set the flag to indicate the node is in the execution state which informs the dispatcher that the node is not available for assignment of a task. A node that has indicated a ready state can be assigned a task that is ready to be moved to the node.

In some embodiments, each node can accept tasks based on the node meeting a scheduling condition. A scheduling condition can be a condition that is met after execution of one task and prior to the node being ready to accept a subsequent task. For example, a scheduling condition can include wait time, a target time, a count limit, downstream availability, and the like. For a wait time scheduling condition, following execution of a task, the node may be idle for a set period of time before accepting a task for processing. In some embodiments, the node can indicate to the dispatcher that the node has entered a wait time, and the length of time the node is to wait. The dispatcher may receive an indication when the node is transitioned to a ready state, may track the time to determine when the node is ready, or may provide the time lapsed and the set period to the scheduler for the scheduler to use to identify when the node should be assigned a task.

In some embodiments, the dispatcher may utilize the use of electronic identifiers (eIDs) associated with each node and queues associated with each state. One or more queues may be used by the dispatcher to monitor adherence to scheduling conditions. A queue may be designated to hold eIDs for nodes in the execution state. Once the dispatcher has been notified that the execution for a node matching an eID on the execution queue is complete, the dispatcher may identify the scheduling condition for the node to determine a corresponding scheduling condition queue, and move the eID from the execution queue to the corresponding scheduling condition queue. Once the scheduling condition is met, the dispatcher may remove the eID from the corresponding scheduling condition queue and provide the eID to a ready queue for the scheduler to use or provide the eID to the execution queue upon immediate assignment of a task.

Accordingly, aspects of the present disclosure enable more efficient CPU usage as the scheduler is not required to continually poll every node for nodal status. Instead, the scheduler is notified by the node upon the node experiencing an event, such as a change in node status. Further, notification of a node status change in real time (as the change occurs) can enable quicker task advancement. The scheduler can immediately identify a secondary node that has notified the scheduler that the secondary node is ready for task assignment and can cause the task to advance. Unlike conventional techniques, the scheduler does not have to identify a state change during a polling operation, identify a secondary scheduler that is ready during a polling operation, and then cause the task to advance.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as small language models (SLMs), large language models (LLMs), vision language models (VLMs), and multimodal language models (MMLMs) (which may process text, voice, image, and/or other data types to generate outputs in one or more formats), systems implemented at least partially using cloud computing resources, systems for performing generative AI operations, and/or other types of systems.

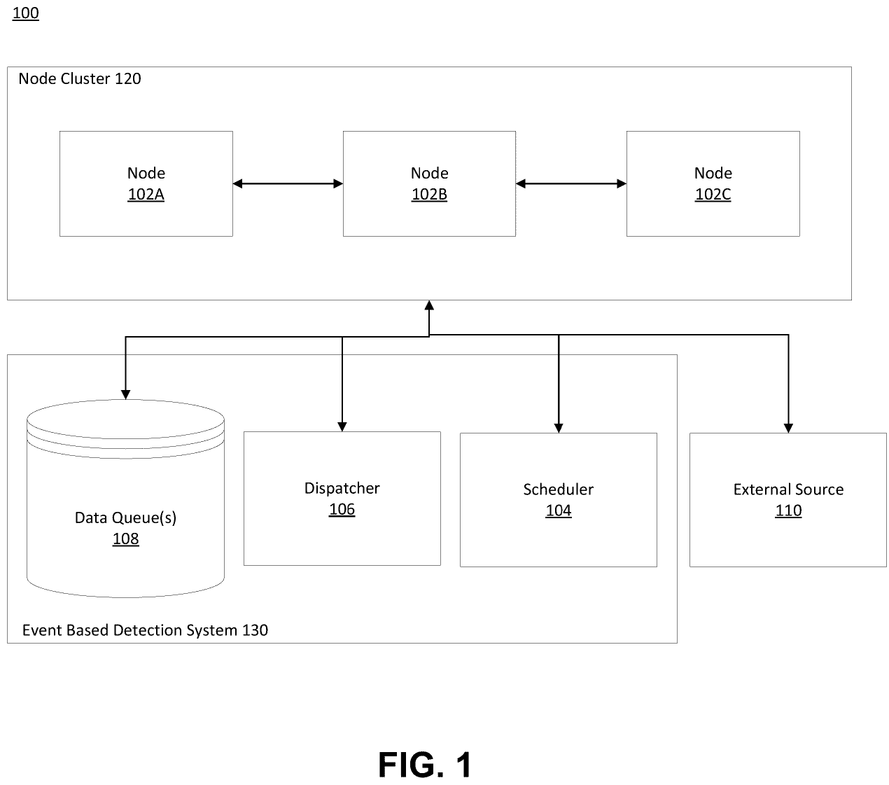

FIG. 1 is a schematic block diagram of an example system architecture 100 providing extensible modular framework event-based task scheduling, according to at least one embodiment. As depicted in FIG. 1, system architecture 100 may include an event based detection system 130 that can monitor and direct task processing assignments within nodes of a node cluster 120, and an external source 110 in communication with the event based detection system 130. The event based detection system 130 can be hosted by one or more computer systems including, for example, a serve machine, a personal computer, a set-top box (STB), a network router, switch or bridge, or any device capable of executing a set (or multiple sets) of instructions to perform any one or more of the methods discussed herein. The event based detection system 130 can be connected to nodes of the node cluster 120 via a network such as a public network (e.g., the Internet), a private network (e.g., a local area network (LAN) or wide area network (WAN)), a wired network (e.g., Ethernet network), a wireless network (e.g., an 602.11 network or a Wi-Fi network), a cellular network (e.g., a Long Term Evolution (LTE) network), routers, hubs, switches, server computers, and/or a combination thereof.

The node cluster 120 can include one or more nodes 102, and the event based detection system 130 can include a scheduler 104, a dispatcher 106, and one or more data queues 108, and/or other component devices (not shown in FIG. 1 for conciseness), as may be deployed by system architecture 100, e.g., parallel processing computing devices (PPU), multimedia processors, neural network accelerators, field-programmable gate arrays (FPGA), application-specific integrated circuits (ASIC), and/or the like. In some embodiments, the external source 110 may not be part of the event based detection system 130 and may instead be external to the event based detection system 130 and may communicate with one or more components of the event based detection system 130. The external source 110 may be, for example external data queues that can cause the event based detection system 130 to be notified when the external data queue is prepared to accept additional data. The notification can cause one or more nodes to process additional tasks that may be provided to the external data queues. In some embodiments, the external source 110 may be, for example, a clock or other timing metric that can cause the event based detection system 130 to be notified when the node cluster 120 is ready to begin processing additional tasks.

In some embodiments, a high-performance artificial intelligence (AI) application can be defined using modular and extensible frameworks (MEF) designed for hardware-accelerated compute graphs. An MEF may comprise independent modules, for example in the form of nodes, that can be utilized in an order by a user for a specific purpose. The specific purpose may be broken down into one or more phases wherein each phase is executed by a node 102 of the plurality of nodes within the system architecture 100. A phase may be a discrete computation for a task, wherein multiple computations, each executed by a separate node, may be required for task processing. For example, a first node 102A may be configured as an input node executing an input phase, a second node 102B may be configured as an inference node executing an inference phase, and a third node 102C may be configured as a sink node executing a sink phase. By ordering the nodes in an order for executing a task, the task may be processed using the existing nodes 102 without having to create new nodes for each specific task.

In some embodiments, the nodes 102 can be associated with one or more states through which the nodes 102 transition during task execution. Transitioning between states can constitute events. An event can be defined as a change in the scheduling term of any node 102 which can be triggered either by expiration of a time duration, an execution of a task within a node 102, an API called by user direction, a message transmission from the external source 110, etc. A node 102 can include an event notifier (e.g., a software component such as a module or a plugin), which can be configured, in some embodiments, to provide the dispatcher 106 with a notification or otherwise enable the dispatcher 106 to detect or identify an event. In some embodiments, the notification can be a flag set at the node 102 upon the node 102 experiencing an event. In some embodiments, the notification can be a message provided to the scheduler 104 instead of the dispatcher 106 upon the node 102 experiencing an event. In such embodiments, the notification can directly cause a scheduler thread maintained by the scheduler 104 to identify that an event has occurred. A scheduler thread can be one of a dispatcher thread, worker thread, and/or async event thread, which includes a series of instructions that are executed upon initialization of the thread.

Within the system architecture 100, the scheduler 104 can be responsible for managing when processing tasks should be executed based on time, conditions, or priorities of the nodes 102. For example, certain nodes 102 may be configured to execute a task only on specific time intervals, or after a sufficient wait time. Nodes 102 may have a condition such as a count that, once met, removes the node from processing task assignments. Nodes 102 may have one or more states that can be used by the scheduler 104 to determine if the node 102 is ready to receive a task for processing using one or more scheduler threads. For example, states may include a ready state in which the node 102 is ready to receive a task for execution, an execution state, in which the node 102 is executing a task, and a wait state which may include a wait time state, a wait event state, a wait state, and the like in which the node 102 is not executing a task and is not ready to receive a task. The number of states used by a node 102 can be determined by the condition. For example, a node 102 without any conditions may have less states than a node 102 that has conditions. The scheduler 104 can prioritize tasks according to priority and can manage multiple tasks executing on multiple nodes 102 simultaneously to prevent processing task assignment conflicts or excessive loads.

In some embodiments, the scheduler 104 may be responsible for directing tasks, events, and/or requests to the nodes 102 using the scheduler threads. In some embodiments, the scheduler 104 may utilize a dispatcher thread and/or a dispatcher 106 to manage data within one or more queues and/or initialize scheduler threads of the scheduler 104. The scheduler 104 can determine which actions should be taken to adjust queue components and can select a thread for completing those actions and can direct the dispatcher 104 to cause the scheduler thread to begin executing.

In some embodiments, the scheduler 104 can be provided with access to one or more data queues 108 which can be stored, for example in a data store. The one or more data queues 108 can, in some embodiments, be stored locally within the event based detection system 130 or it can be communicatively coupled to the event based detection system 130 such that they are stored external to the event based detection system 130. The one or more data queues 108 can be discrete queues that list electronic identifiers (eIDs) for nodes 102 based on the scheduler's 104 determination of node 102 availability. For example, a first data queue of the data queues 108 can be configured to store eIDs of nodes 102 that are available and ready for task assignment. A second data queue of the data queues 108 can be configured to store identifiers of nodes 102 that are configured as time based execution nodes 102 that are currently in a wait time state. A node 102 that is a time based execution node may only accept a task for processing after a certain amount of time has passed. During the time in which the node 102 is unavailable for task assignment (e.g. the wait time state), an eID for the node 102 may reside in a wait queue of the one or more data queues. Upon detection that the node 102 has met the condition for the wait time and has moved to a ready state, the scheduler 104 may cause removal of the eID of the node 102 from the data queue 108 associated with a wait time and provide the eID to a data queue 108 associated with a ready state. An eID from the ready state data queue 108 can be used to identify a node 102 that is prepared to receive a task processing assignment.

In some embodiments, data queues 108 for each node phase may be maintained separately. For example, a scheduler 104 may utilize a first set of queues for nodes 102 that are configured to execute a first phase, for example an input phase. Each state that is utilized by any node 102 that executes the first phase can be associated with a dedicated queue 108 of a first set of dedicated queues. Nodes 102 associated with a second phase may be associated with a second set of dedicated queues 108 for each state of the nodes 102. When a node 102 has finished executing a phase, the scheduler 104 may look to advance the task to the next phase. Using the dedicated queues 108 associated with the next phase, the scheduler 104 can identify from a ready queue 108, a node 102 associated with the second phase that is ready to process a task. For example, node 102A can be configured as an input node that may execute a first phase of a task. Upon completion of the task execution, node 102A may notify the dispatcher 106 that the task is ready to be advanced to the second phase. The dispatcher 106 can indicate to the scheduler 104 that the dispatcher 106 is awaiting instructions from the scheduler 104 for next steps based on the notification. The scheduler 104 may identify a ready queue of the data queues 108 associated with the second phase, such as an inference phase, to identify node 102B as being available for task execution. The scheduler 104 can then direct the dispatcher 106 to cause a thread maintained by the scheduler 104 to advance the task from node 102A to node 102B. In some embodiments, node cluster 120 can include multiple nodes 102 that can execute each phase. In such embodiments, when directing the task to be advanced from node 102A to node 102B, the scheduler 104 may provide location instructions and/or communication instructions to nodes 102A and/or 102B to enable task advancement. For example, the location instructions may indicate a direct communication link to use to advance the task to the correct node 102B, a routing address for the correct node 102B, or other ways of identifying the next node 102B to process the task. Communication instructions may include a time delay for providing the task, instructions to wait for additional indications from the scheduler 104 before advancing the task, and the like.

In some embodiments, when determining a node 102 that is ready to receive a task from a ready queue of the data queues 108, the scheduler 104, for example using scheduler threads, may select an eID based on data queue logic. For example, the scheduler 104, using scheduler threads, may use a first in, first out logic to retrieve an eID of the node that has been in the ready state the longest. In another example, the scheduler 104, using scheduler threads, may utilize a last in, first out logic in which the scheduler 104 may retrieve an eID of a node 102 that has been most recently added to the queue 108 and therefore most recently transitioned into the ready state. In some embodiments, additional queue logics can be utilized by the scheduler 104, for example using scheduler threads, to select eIDs, and thereby nodes 102, from the queue in order to determine a node 102 for task advancement to a subsequent phase.

To manage the queues 108, the event based detection system 130, for example at the scheduler 104, can utilize one or more threads (e.g., scheduler threads when operated by the scheduler). The threads can be activated by the dispatcher 106 and can execute a sequence of commands based on detected events within the system architecture 100. A thread may be configured to manage removal of eIDs from a queue based on a change in state of the node. Upon detection of a node state change, the thread may be woken up by the dispatcher 106 upon instruction from the scheduler 104, may pop a first eID from the execution state queue, and return to sleep. For example, a thread may be woken up upon detection that a node 102 from a previous phase has moved from an execution state. The thread may pop a second eID from the ready queue 108 of a node 102 ready to receive a task assignment and return to sleep while the dispatcher 106 activates the next thread that can cause the task to be provided to the node associated with the eID. Similarly, a thread may be configured to append the first or second eID to a queue 108 for the ready state and the execution state respectively.

In some embodiments, one or more threads may be communicatively connected, such that a first thread may direct a second thread to complete an action. In some embodiments, as part of the functionality of the threads, a first thread may wake a second thread, thus commencing the second threads sequence. For example, a first thread may be configured to obtain an eID for a node that has an associated wait time and is therefore in a wait time queue. When the wait time has passed, the thread may notify a second thread that the node 102 associated with the eID has completed the wait time and the eID should be moved to a queue associated with the next state of the node. The second thread may be configured to move the eID from the wait queue to the subsequent queue. In some embodiments, threads can be operating simultaneously to manage queues to execute multiple tasks on multiple nodes.

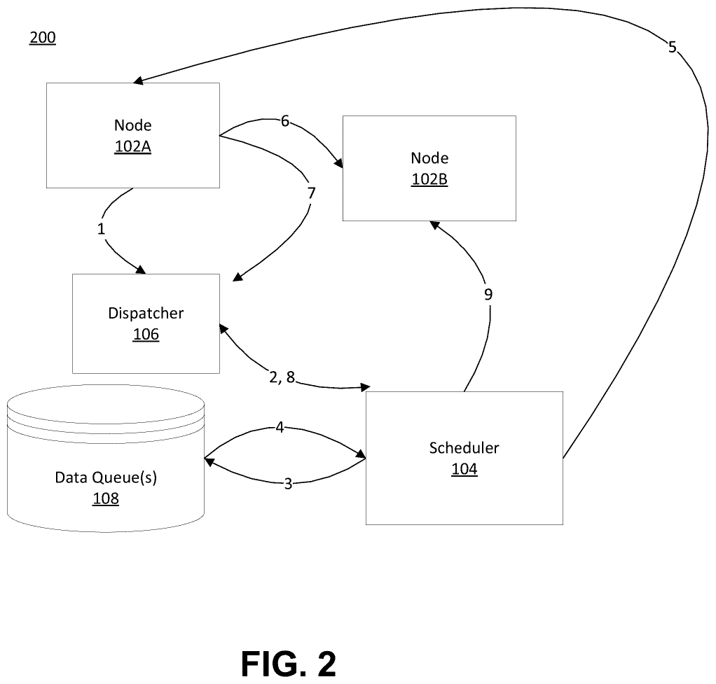

FIG. 2 illustrates an example data flow 200 between the nodes 102, the scheduler 104, the dispatcher 106, and one or more data queues 108 of the computing system of FIG. 1, according to at least one embodiment. The example data flow 200 begins after a node 102A has already been provided and has executed an initial phase of a task. After execution, the node 102A can notify (1) dispatcher 106 that the task processing is completed. In some embodiments, the dispatcher 106 can request instructions from the scheduler 104 (2) on which scheduler thread to activate. The dispatcher 106 can utilize the instructions from the scheduler 104 to save the state of the currently running thread and transfer control to the scheduler thread identified by the scheduler 104.

The scheduler thread activated by the dispatcher 106 can be managed independently by the scheduler 104. During execution of a first phase by the node 102A, the scheduler 104 may support a worker thread that is causing the execution. Upon notification to the dispatcher 106 that the node 102A has completed execution, the scheduler 104 may identify a scheduler thread to be activated for the purpose of moving the task to the next phase executed by a next node 102B. For example, the dispatcher 106 may provide a connection from the worker thread that was used to execute the task on the node 102A to one or more scheduler threads. For example, the connection may be to a dispatcher thread that can be used to update queues of the data queues 108 and a worker thread to identify a next node 102B and execute the second phase task processing. In some embodiments, updating the queues of the data queue 108 may include popping the eID for the node 102A from a queue associated with an executing state and pushing the eID onto a queue associated with the next state for the node 102A. In some embodiments, the worker thread may automatically cause a dispatcher thread to execute based on the completion of the worker thread process.

In some embodiments, the dispatcher thread on the scheduler 104 may access one or more queues (3) of the data queues 108 to update the queues based on the event notification that the node 102A has executed the task (e.g., by popping the eID from the execution state queue and pushing it onto a subsequent state queue). The scheduler threads of the scheduler 104 can be executed in parallel, such that upon notification of the event to the dispatcher 106, a first thread can be executed to move the eID for the first node 102A to a queue associated with the next state for the node 102A. A second thread can be executed to enable task processing to continue by identifying a node 102B to execute a second phase of the task.

In some embodiments, all nodes 102 executing the first phase are associated with a first set of data queues. The first set may include one or more queues associated with each state of the node logic. After executing a task, the node 102A may move from an executing state to enter a new state. The executing state may be associated with a first queue of the first set of queues. The new state may be associated with a second queue of the first set of queues. A dispatcher thread may be configured to move the eID from the first queue to the second queue. The dispatcher thread, in some embodiments, may be provided scheduling conditions by the scheduler 104 or may check scheduling conditions for the node 102A to identify the second queue. The dispatcher thread may then pop the eID from the first queue and push the eID onto the second queue. In some embodiments, the dispatcher thread may then perform deadlock detection to determine if any thread of the scheduler threads is stuck in a state where they cannot proceed because each thread is waiting for another to release a resource.

Parallel to, or in conjunction with, the dispatcher thread, the dispatcher 106 may enable a worker thread on the scheduler 102 to identify a second node 102B to continue executing the task. In some embodiments, all nodes 102 executing the second phase are associated with a second set of data queues. The second set may include one or more queues associated with each state of the node logic. The worker thread may access the second set of queues to determine a node 102B of the nodes associated with the second phase that is available for task assignment. A ready queue of the second set of queues may include one or more eIDs for nodes that are in the ready state. The worker thread may then pop the eID from the ready queue of the second set of queues and push the eID onto an execution queue of the second set of queues.

The eID identified by the worker thread may be utilized by the scheduler 104 (4) to generate instructions for the first node 102A. The instructions may instruct the first node 102A to provide a specific node with the executed task. As described above, one or more nodes may be capable of executing the next phase and the first node 102A may be communicatively coupled to each node that may execute the next phase. The instructions can inform the first node 102A which of the coupled nodes executing the second phase is prepared for the task.

The scheduler 104, for example using the threads, can provide the instructions to the node 102A (5) and the node 102A can provide the task, for example, by communicating task ID, processed task data address, and/or processed task data, based on the instructions (6) to the second node 102B for processing. The first node 102A may provide an event notification (7) to the dispatcher 106 to indicate that the event of providing the task to the second node 102B has been completed. The event notification may be a flag read by the dispatcher 106, a message sent to the dispatcher 106, or a notification provided directly to the worker thread on the scheduler 104.

The dispatcher 106 may notify the scheduler 104 of the event (8) causing the worker thread of the scheduler 104 to continue to instruct the node 102B to execute (9). In some embodiments, no event notification and no execution instruction from the worker thread are required for executing the task on the second node 102B. Rather, in some embodiments, upon receiving the task, the second node 102B will automatically execute and provide an event notification upon completion of the task execution.

In some embodiments, operations 1-4 can be used to update queues within the data queues 108 upon the occurrence of various events. For example, an external event may provide a notification in a manner according to that of operation 1, and the dispatcher 106 may receive the notification, provide the notification to the scheduler 104, and direct one or more scheduler threads to execute. The worker threads may update the queues and cause task assignment as required by the event, updated queues, and/or task processing requirements.

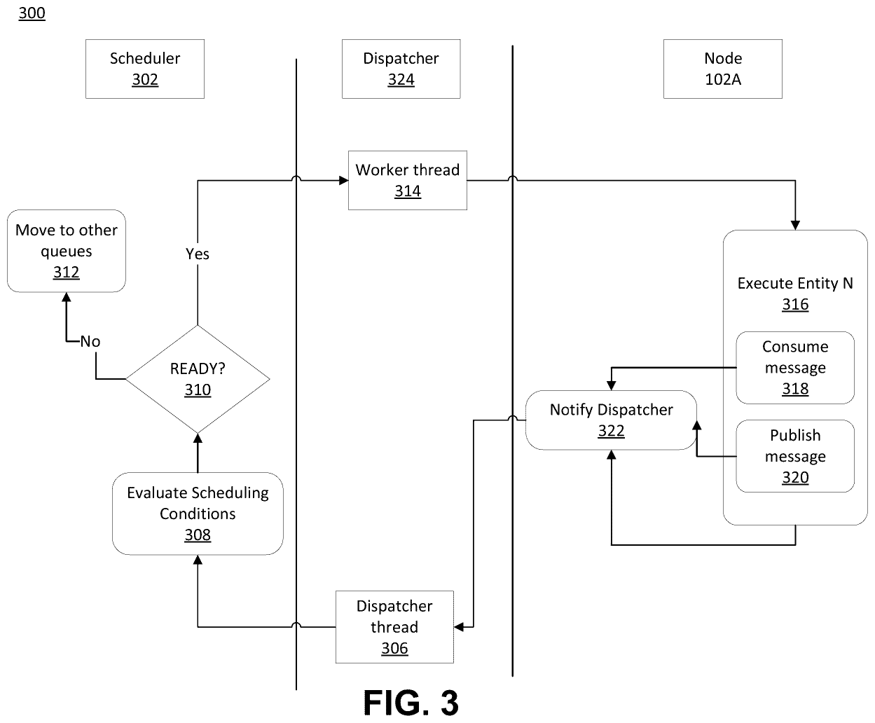

FIG. 3 illustrates example logic flow 300 between a scheduler 302, a dispatcher 324, and a node 102A of FIG. 1, according to at least one embodiment. In some embodiments, the scheduler 302 and the dispatcher 324 may be or include the scheduler 104 and the dispatcher 106, respectively. As described in FIG. 2, the dispatcher 324 may receive a notification of an event, for example a notification 322 that the first node 102A has completed execution of a task processing assignment and the eID should be moved from an execution state queue to a next state queue. The dispatcher 324 can receive the notification 322 and can initialize a dispatcher thread 306 of the scheduler threads. As stated above, the dispatcher thread may be responsible for removing the eID for the first node 102A from a data queue 108 that is associated with an execution state of the first node 102A. The dispatcher thread 306 may request information from the scheduler 302 regarding scheduling terms 308 for the node 102A. In some embodiments, the node 102A may have scheduling conditions that should be met prior to the node 102A being ready to execute a next task. The scheduling conditions can be, for example, a wait time, a count increase, an event wait, or the like.

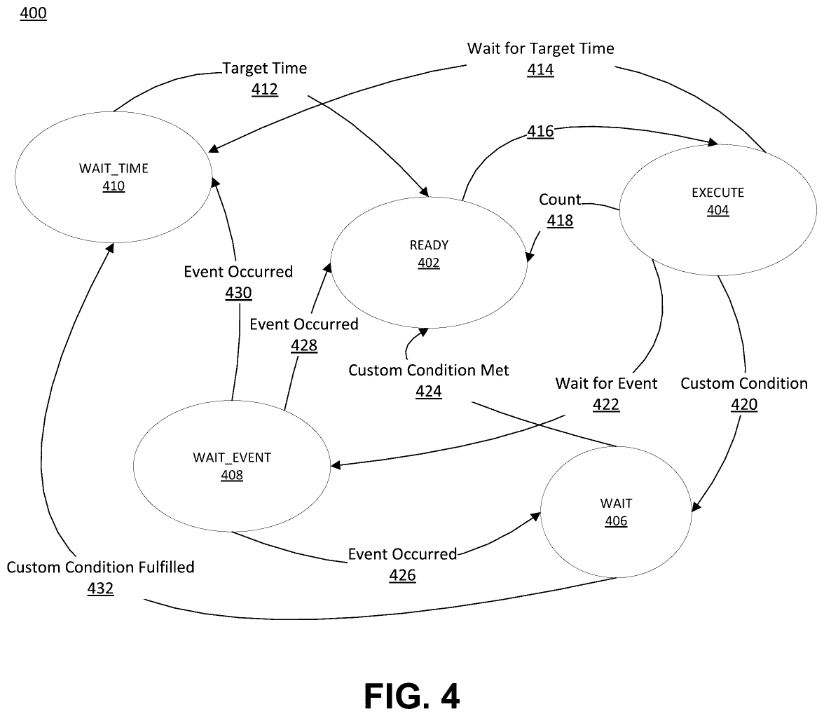

The scheduling conditions determined by the scheduler 302 can define whether the node 102A is ready 310 for a task assignment. If the queue is not ready for a task assignment, the eID associated with the node 102A can be moved to a queue other than the ready state queue according to the scheduling conditions identified by the scheduler 302. The dispatcher thread 306 can be, in some embodiments, responsible for popping the eID from the executing queue and pushing it onto a queue associated with the identified next state. More description on scheduling conditions and node states can be found in FIGS. 4-8.

In some embodiments, the queue is ready 310 for a task assignment as determined by the scheduling conditions 308. The dispatcher 324 can, in some embodiments, cause a worker thread 314 to wake and enable the node 102A to be assigned a task and execute a task 316. Execution of a task can include, in some embodiments, consuming a message 318 and publishing a message 320. The published message 320 may be used to notify the dispatcher 322 that the additional task has been executed. As described above, dispatcher threads 306 and worker threads 314 may be initialized upon the notification of other events such as external events, time completion events, count events, and the like.

FIG. 4 illustrates an example logic flow 400 of states of a node 102 operating with a time delay condition, according to at least one embodiment. The example logic flow 400 shows a node 102 with five states: a ready state 402, an execute state 404, a wait state 406, a wait event state 408, and a wait time state 410. In the ready state 402, the node 102 is prepared to accept a task assignment from the scheduler 104. Receiving a task assignment 416 from the scheduler 104 moves the node 102 from the ready state 402 to the execute state 404. In the execute state 404, the node 102 executes the task processing according to the task phase associated with the node 102. Upon completion of the execute state 404, depending on the configurations of the node 102, the node can advance to the wait state 406, the wait event state 408, or the wait time state 410.

In some embodiments, a node 102 can be configured to except tasks on the condition that a target wait time has been reached between execution and assignment of an additional task. If the node 102 is configured to delay transfer into the ready state 402, the node 102 may advance from the execute state 404 to wait for the target time 414 in the wait time state 410. A target time can be, for example, set by the dispatcher 106, the scheduler 104, can be preconfigured as part of the phase assigned to the node 102, and the like. The node 102 can maintain a clock internally such that when the node enters the wait times state 410, a first clock time can be identified. Upon the clock reaching a second clock time which is the first clock time adjusted by the target time, the target time 412 has been reached and the node is advanced to the ready state 402.

In some embodiments, a node 102 may be configured with a custom condition 420 and may be advanced to the wait state 406 to wait until the condition is fulfilled 432. A condition can be, for example, an event identified from an external source, an event triggered by a user, and the like. In some embodiments, a notification that the condition has occurred can cause the node to advance to a wait time state 410. The node may remain in the wait time state 410 until the target time has been met 424 and the node is advanced into the ready state 402.

In some embodiments, after execute state 404, the node 102 may be configured to wait for an event 422 prior to beginning a wait time. The node 102 may advance from the execute state 404 to the wait event state 408. Depending on the configuration of the node 102, upon the events occurrence 426, 428, 430, the node 102 may advance to the wait state 406, the ready state 402, or the wait time state 410 and can proceed as described above. It should be appreciated, that a custom condition 420, an event trigger 422, and/or a wait for a target time 414 can occur in one or more combinations such that only one, two, or all three conditions may be required in any order before the node can transition from the execute state 404, through the condition states 406, 408, and 410, and to the ready state 402.

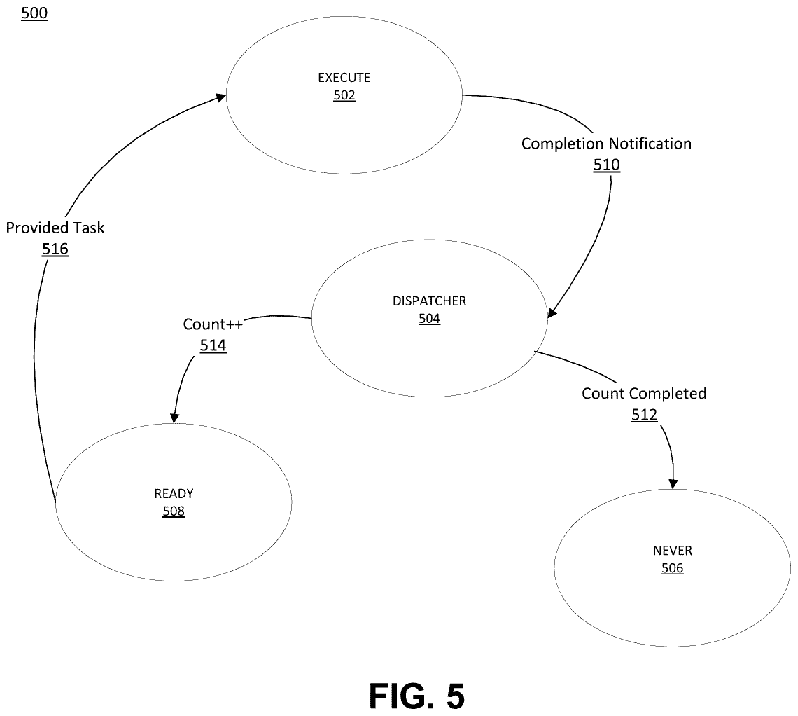

FIG. 5 illustrates an example logic flow 500 of states of a node 102 operating with a count condition, according to at least one embodiment. In some embodiments, a node 102 can be configured with a count condition. A count condition can allow a node 102 to accept and process a finite number of tasks before being removed from consideration for task assignment. A count condition node may, in some embodiments, include an execute state 502, a dispatcher state 504, a never state 506, and/or a ready state 508. After the node 102 has executed a task within the execute state 502, an execution notification 510 can be provided to the dispatcher 504. In some embodiments the execution notification 510 can be a flag set at the node 102 that is identified by the dispatcher 106, can be a notification provided as a message to the dispatcher 106, or the like. After the notification is received at the dispatcher 106, the dispatcher 106 can provide the notification to the scheduler 104 for review of an existing count for the node 102. The count can be a current number of tasks that have been processed by the node 102. In some embodiments, the scheduler 104 can identify the count is less than account threshold for the node 102, and increase the count 514 and move the node 102 into the ready state 508. From the ready state 508, the node 102 can be provided a task 516 and moved into the execution state 502.

In some embodiments, the scheduler 104 may identify within the dispatcher state 504 that the count has met the count threshold. On the condition that the count has met the count threshold such that the count has been completed 512, the node 102 can be moved into the never state 506 and can cease executing tasks. Ask described above, an eID for the node 102 within the never state 506 may be stored within a never queue of the data queues 108. The eID within a never queue of the data queues 108 can prevent the scheduler 104 using the scheduler threads from assigning the node 102 a task. In some embodiments the node 102 can be reset by reinitializing the node 102 into the ready state 508 and resetting the count to zero. In some embodiments, a user can direct the node 102 to return to the ready state 508 and reset the count. Upon resetting the node 102, the eID within the never queue of the data queues 108 can be moved to a ready queue of the data queues 108, the execute queue of the data queues 108, or the like.

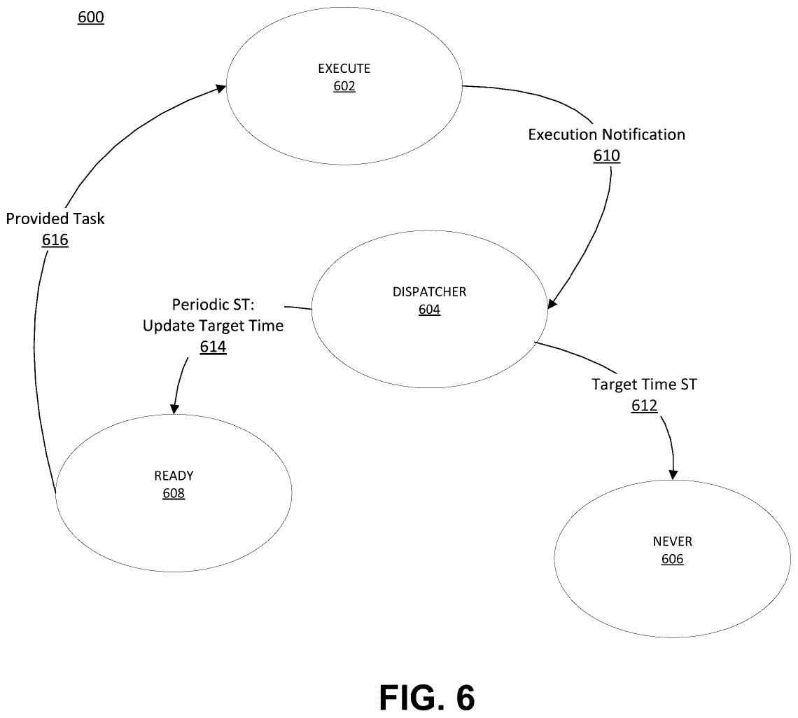

FIG. 6 illustrates an example logic flow 600 of a node 102 operating with a target time condition, according to at least one embodiment. In some embodiments, a node 102 can be configured with a target time condition. A target time condition can allow a node 102 to accept and process tasks only until a target time is reached. A target time condition node, in some embodiments, can include an execute state 602, a dispatcher state 604, a never state 606, and a ready state 608. After a node 102 has executed a task within the execute state 602, an execution notification 610 can be provided to the dispatcher 106 within a dispatcher state 604. In some embodiments, the execution notification 610 can be a flag set at the node 102 that is identified by the dispatcher 106, can be a notification provided as a message to the dispatcher 106, or the like. After the notification is received at the dispatcher 106, the dispatcher 106 can review the time associated with the node 102. The time can be identified from a clock associated with the node 102 that begins, for example, upon initialization of the node 102, execution of a first task on the node 102, or the like.

In some embodiments, the dispatcher 106 within the dispatcher state 604 may identify that the time is not equal to a target time. The target time, in some embodiments, can be set by the dispatcher 106, the scheduler 104, a user initializing the MEF event based detection system 130, and the like. Upon determining that the target time has not been reached, the target time may be updated 614 and the node may be advanced to the ready state 608. The dispatcher 106 may enable a scheduler thread to provide the node 102 with a task 616, thus moving the node 102 into the execute state 602.

In some embodiments, the scheduler 104, during the dispatcher state 604, may identify that the time is equal to the target time. Upon determining that the target time has been reached 612, the node 102 may be advanced into the never state 606. Within the never state 606, the node 102 may not receive and execute tasks. As described above, an eID for the node 102 that is in a never state 606 can be placed in a never queue of the data queues 108. An eID within the never queue, can prevent the dispatcher 106 from assigning a task for processing to the node associated with the eID. In some embodiments, the node 102 can be reset by returning the count time to zero, restarting the clock, and moving the eID to a ready queue associated with the ready state 608 of the node 102.

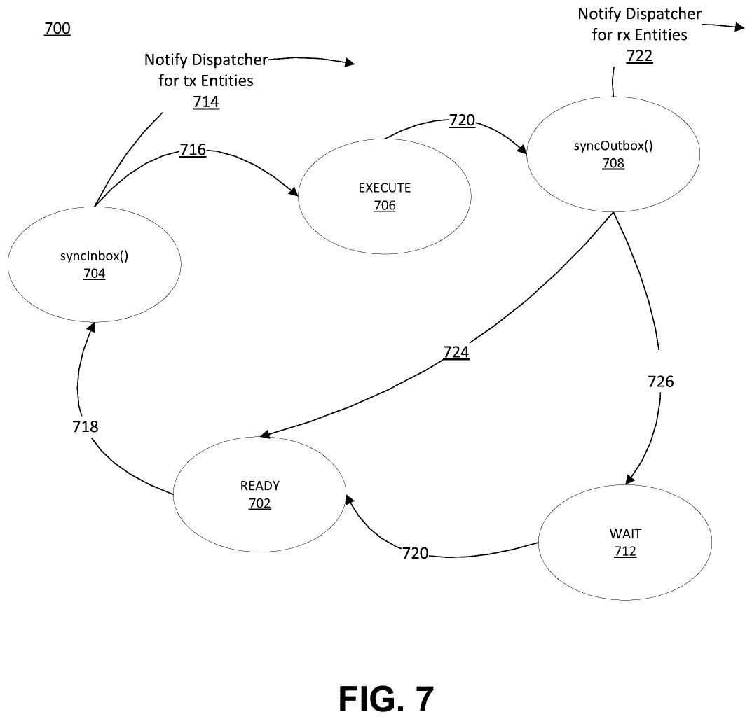

FIG. 7 illustrates an example logic flow 700 of phases of a node 102 operating based on external events, according to at least one embodiment. In some embodiments, a condition for a node 102 may be based on an event provided by an external device, such as device 110 of FIG. 1. A node with an external event condition can, in some embodiments, comprise a ready state 702, a sync inbox state (syncInbox( )) 704, an execute state 706, a sync outbox state (syncOutbox( )) 708, and a wait state 712. A node 102 may be idling in the ready state 702, awaiting a task processing assignment. Upon the detection of an event 718 at the syncInbox( ) 704, the node 102 may be assigned a task. The syncInbox( ) 704 may be an inbox that is configured to receive messages from an external source to notify the system 100 that an event has occurred. The example logic flow 700 shows a node 102 with scheduling conditions that require an external event occur prior to execution of a task. After the event has occurred 716, the node moves into the execute state 706. In some embodiments, the node 102 may also notify the dispatcher 714 that the external event has occurred so the dispatcher can activate dispatcher threads and/or worker threads to manage the queues of the data queues 108 associated with the node 102.

After a node 102 has executed a task within the execute state 706, an execution notification can be provided to the syncOutbox( ) 708 to notify the external device that the task execution based on the external event has occurred. The syncOutbox( ) can notify the dispatcher 722 that the event of processing the task has occurred and the dispatcher can enable worker threads and/or dispatcher threads to manage the queues.

The dispatcher in coordination with the scheduler can move 724, 726 the node 102 to the ready state 702 or to the wait state 712 to wait for an event and/or a period of time prior to being ready for execution. The wait state 712 can be transitioned 720 into the ready state 702 upon satisfaction of the condition. In some embodiments, the node 102 can move directly into the ready state 702 from the execute state 706.

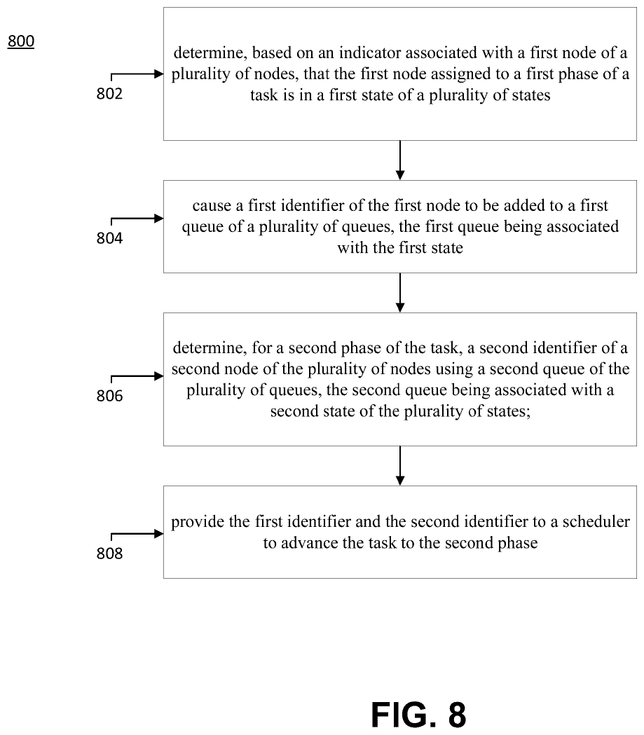

FIG. 8 is a flow diagram 800 of an example method of event-based task scheduling for module extensible framework, according to at least one embodiment Method 800 may be performed in the context of cloud-based programming, computational simulations, autonomous driving applications, industrial control applications, provisioning of streaming services, video monitoring services, computer-vision based services, artificial intelligence and machine learning services, mapping services, gaming services, virtual reality or augmented reality services, and many other contexts, and/or in systems and applications for providing one or more of the aforementioned services. Method 800 may be performed using one or more processing devices (e.g., CPUs, GPUs, accelerators, PPUs, DPUs, etc.), which may include (or communicate with) one or more memory devices. In some embodiments, method 800 may be performed using event based detection system 130, one or more nodes 102, a scheduler 104, a dispatcher 106, and one or more data queues 108. In some embodiments, some of the processing units performing any operations of method 800 may be executing instructions (e.g., firmware or software) stored on non-transient computer-readable storage media. In some embodiments, some of the processing computing devices performing any of the operations of method 800 may be hardware circuits that operate without software involvement. In some embodiments, any of method 800 may be performed using multiple processing threads, individual threads executing one or more individual functions, routines, subroutines, or operations of the method. In some embodiments, processing threads implementing any of method 800 may be synchronized (e.g., using semaphores, critical sections, and/or other thread synchronization mechanisms). Alternatively, processing threads implementing any of method 800 may be executed asynchronously with respect to each other. Various operations of any of method 800 may be performed in a different order compared with the order shown in FIG. 8. Some operations of any of method 800 may be performed concurrently with other operations. In some embodiments, one or more operations shown in FIG. 8 may not always be performed.

Referring to FIG. 8, at block 802, one or more processors executing method 800 may determine, based on an indicator associated with a first node of a plurality of nodes, that the first node assigned to a first phase of a task is in a first state of a plurality of states. In some embodiments, the plurality of nodes 102 can be or otherwise include CPU, GPU, Network Controller, Components, and DPU nodes. The indicator may pertain to an event that is internal or external to the computing system. For example, the indicator may be an indicator by a node of a change of state of the node. The indicator may be an external device providing a message to the event based detection system 130. In some embodiments, the indicator may be an indicator by the node of having finished executing and/or processing a task.

The node can be associated with a phase of task processing. Phases of task processing may be completed sequentially such that a first phase is followed by a second phase, which is followed by a third phases, etc. The nodes within each phase may be associated with scheduling conditions. A node, according to the scheduling conditions may or may not be available for a new task processing assignment immediately following the execution of an initial task assignment. Scheduling conditions can be represented by states. A node may be associated with one or more states including, but not limited to a ready state, an execution state, a wait state, a count state, a wait time state, a wait event state, and the like. After an indicator, such as notification of the completed execution of a task, the node may move into a ready state and be ready to be assigned a next task. Alternatively, the node may move into a wait state.

The method continues at block 804. After the indicator has caused the computing system, for example at the scheduler and/or the dispatcher, to determine that the first node is in a first state, the one or more processors can cause a first identifier of the first node to be added to a first queue of a plurality of queues, the first queue being associated with the first state. For example, a first identifier may be an eID that can be used to identify a node that is in a state based on the contents of the queue. As described above, if the first state is determined to be a ready state, the first identifier can be added to (e.g., pushed onto) a queue associated with the ready state. Alternatively, if the first state is determined to be a wait state, the first identifier can be added to a queue associated with the wait state. A node with an eID in the ready queue can be assigned a task for processing. A node with an eID in the wait queue cannot be assigned a task for processing.

At block 806, the one or more processors can determine, for a second phase of the task, a second identifier of a second node of the plurality of nodes using a second queue of the plurality of queues, the second queue being associated with a second state of the plurality of states. As described above, separate queues for various nodal states can be maintained for nodes associated with the first phase and nodes associated with the second phase. After processing a task in the first phase, the one or more processors may search a ready queue associated with the second phase to identify a node that will complete the second phase and is ready to accept at processing assignment. The one or more processors can identify the node by the eID within the ready queue.

After determining the second node, the one or more processors can provide the first identifier and the second identifier to a scheduler to advance the task to the second phase at block 808. In some embodiments, the nodes of the first phase and the nodes of the second phase are communicatively coupled such that any node processing the first phase can transmit data to any node processing the second phase. The scheduler can provide instructions to the first node to identify the second node that the first node should provide the task to. In some embodiments, the identification and instructions are all completed by threads within the scheduler that are woken up and initialized by a dispatcher.

### Inference and Training Logic

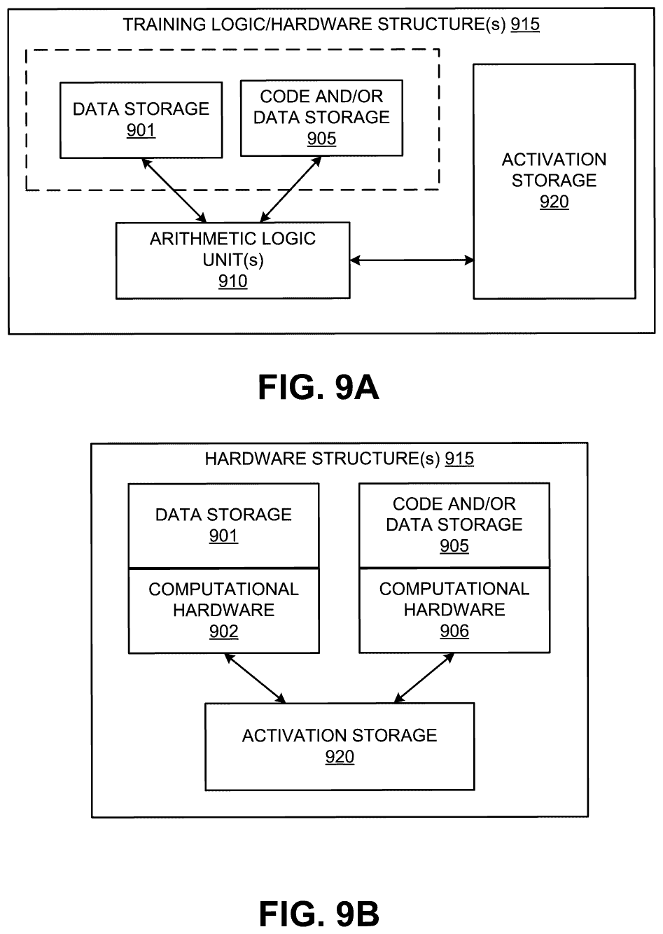

FIG. 9A illustrates inference and/or training logic 915 used to perform inferencing and/or training operations associated with one or more embodiments.

In at least one embodiment, inference and/or training logic 915 may include, without limitation, code and/or data storage 901 to store forward and/or output weight and/or input/output data, and/or other parameters to configure neurons or layers of a neural network trained and/or used for inferencing in aspects of one or more embodiments. In at least one embodiment, training logic 915 may include, or be coupled to code and/or data storage 901 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 901 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 901 may be included with other on-chip or off-chip data storage, including a processor's L1, L2, or L3 cache or system memory.

In at least one embodiment, any portion of code and/or data storage 901 may be internal or external to one or more processors or other hardware logic devices or circuits. In at least one embodiment, code and/or code and/or data storage 901 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 901 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 915 may include, without limitation, a code and/or data storage 905 to store backward and/or output weight and/or input/output data corresponding to neurons or layers of a neural network trained and/or used for inferencing in aspects of one or more embodiments. In at least one embodiment, code and/or data storage 905 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 915 may include, or be coupled to code and/or data storage 905 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 905 may be included with other on-chip or off-chip data storage, including a processor's L1, L2, or L3 cache or system memory. In at least one embodiment, any portion of code and/or data storage 905 may be internal or external to one or more processors or other hardware logic devices or circuits. In at least one embodiment, code and/or data storage 905 may be cache memory, DRAM, SRAM, non-volatile memory (e.g., flash memory), or other storage. In at least one embodiment, a choice of whether code and/or data storage 905 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 901 and code and/or data storage 905 may be separate storage structures. In at least one embodiment, code and/or data storage 901 and code and/or data storage 905 may be a combined storage structure. In at least one embodiment, code and/or data storage 901 and code and/or data storage 905 may be partially combined and partially separate. In at least one embodiment, any portion of code and/or data storage 901 and code and/or data storage 905 may be included with other on-chip or off-chip data storage, including a processor's L1, L2, or L3 cache or system memory.

In at least one embodiment, inference and/or training logic 915 may include, without limitation, one or more arithmetic logic unit(s) (“ALU(s)”) 910, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 920 that are functions of input/output and/or weight parameter data stored in code and/or data storage 901 and/or code and/or data storage 905. In at least one embodiment, activations stored in activation storage 920 are generated according to linear algebraic and or matrix-based mathematics performed by ALU(s) 910 in response to performing instructions or other code, wherein weight values stored in code and/or data storage 905 and/or data storage 901 are used as operands along with other values, such as bias values, gradient information, momentum values, or other parameters or hyperparameters, any or all of which may be stored in code and/or data storage 905 or code and/or data storage 901 or another storage on or off-chip.

In at least one embodiment, ALU(s) 910 are included within one or more processors or other hardware logic devices or circuits, whereas in another embodiment, ALU(s) 910 may be external to a processor or other hardware logic device or circuit that uses them (e.g., a co-processor). In at least one embodiment, ALU(s) 910 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 901, code and/or data storage 905, and activation storage 920 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 920 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 920 may be cache memory, DRAM, SRAM, non-volatile memory (e.g., flash memory), or other storage. In at least one embodiment, activation storage 920 may be completely or partially within or external to one or more processors or other logical circuits. In at least one embodiment, a choice of whether activation storage 920 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 915 illustrated in FIG. 9A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 915 illustrated in FIG. 9A may be used in conjunction with central processing unit (“CPU”) hardware, graphics processing unit (“GPU”) hardware or other hardware, such as field programmable gate arrays (“FPGAs”).

FIG. 9B illustrates inference and/or training logic 915, according to at least one embodiment. In at least one embodiment, inference and/or training logic 915 may include, without limitation, hardware logic in which computational resources are dedicated or otherwise exclusively used in conjunction with weight values or other information corresponding to one or more layers of neurons within a neural network. In at least one embodiment, inference and/or training logic 915 illustrated in FIG. 9B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 915 illustrated in FIG. 9B may be used in conjunction with central processing unit (CPU) hardware, graphics processing unit (GPU) hardware or other hardware, such as field programmable gate arrays (FPGAs). In at least one embodiment, inference and/or training logic 915 includes, without limitation, code and/or data storage 901 and code and/or data storage 905, which may be used to store code (e.g., graph code), weight values and/or other information, including bias values, gradient information, momentum values, and/or other parameter or hyperparameter information. In at least one embodiment illustrated in FIG. 9B, each of code and/or data storage 901 and code and/or data storage 905 is associated with a dedicated computational resource, such as computational hardware 902 and computational hardware 906, respectively. In at least one embodiment, each of computational hardware 902 and computational hardware 906 comprises one or more ALUs that perform mathematical functions, such as linear algebraic functions, only on information stored in code and/or data storage 901 and code and/or data storage 905, respectively, result of which is stored in activation storage 920.

In at least one embodiment, each of code and/or data storage 901 and 905 and corresponding computational hardware 902 and 906, respectively, correspond to different layers of a neural network, such that resulting activation from one storage/computational pair 901/902 of code and/or data storage 901 and computational hardware 902 is provided as an input to a next storage/computational pair 905/906 of code and/or data storage 905 and computational hardware 906, in order to mirror a conceptual organization of a neural network. In at least one embodiment, each of storage/computational pairs 901/902 and 905/906 may correspond to more than one neural network layer. In at least one embodiment, additional storage/computation pairs (not shown) subsequent to or in parallel with storage/computation pairs 901/902 and 905/906 may be included in inference and/or training logic 915.

### Neural Network Training and Deployment

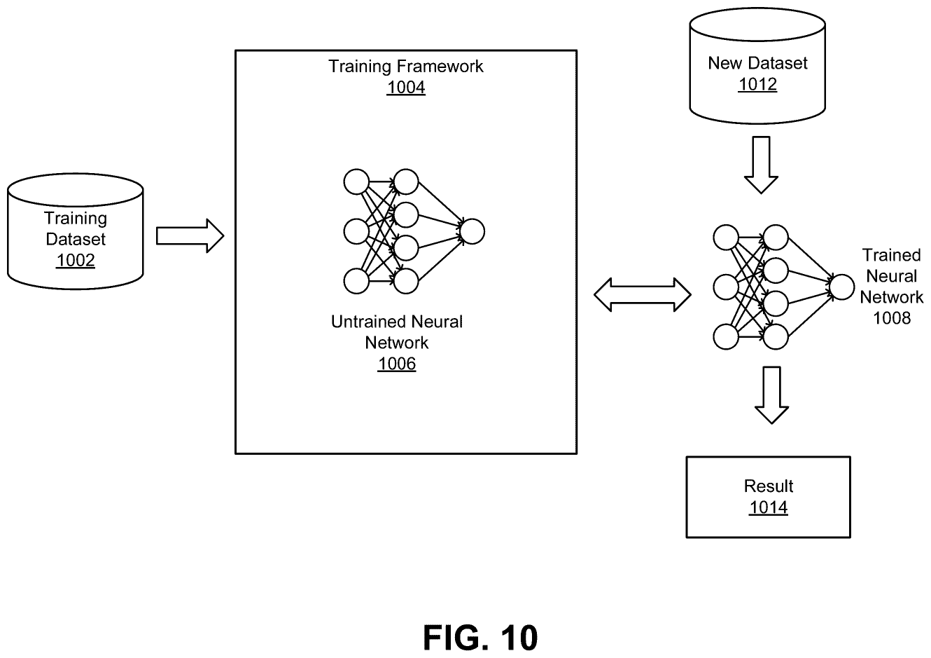

FIG. 10 illustrates training and deployment of a deep neural network, according to at least one embodiment. In at least one embodiment, untrained neural network 1006 is trained using a training dataset 1002. In at least one embodiment, training framework 1004 is a PyTorch framework, whereas in other embodiments, training framework 1004 is a TensorFlow, Boost, Caffe, Microsoft Cognitive Toolkit/CNTK, MXNet, Chainer, Keras, Deeplearning4j, or other training framework. In at least one embodiment, training framework 1004 trains an untrained neural network 1006 and enables it to be trained using processing resources described herein to generate a trained neural network 1008. In at least one embodiment, weights may be chosen randomly or by pre-training using a deep belief network. In at least one embodiment, training may be performed in either a supervised, partially supervised, or unsupervised manner.

In at least one embodiment, untrained neural network 1006 is trained using supervised learning, wherein training dataset 1002 includes an input paired with a desired output for an input, or where training dataset 1002 includes input having a known output and an output of neural network 1006 is manually graded. In at least one embodiment, untrained neural network 1006 is trained in a supervised manner and processes inputs from training dataset 1002 and compares resulting outputs against a set of expected or desired outputs. In at least one embodiment, errors are then propagated back through untrained neural network 1006. In at least one embodiment, training framework 1004 adjusts weights that control untrained neural network 1006. In at least one embodiment, training framework 1004 includes tools to monitor how well untrained neural network 1006 is converging towards a model, such as trained neural network 1008, suitable to generating correct answers, such as in result 1014, based on input data such as a new dataset 1012. In at least one embodiment, training framework 1004 trains untrained neural network 1006 repeatedly while adjusting weights to refine an output of untrained neural network 1006 using a loss function and adjustment algorithm, such as stochastic gradient descent. In at least one embodiment, training framework 1004 trains untrained neural network 1006 until untrained neural network 1006 achieves a desired accuracy. In at least one embodiment, trained neural network 1008 can then be deployed to implement any number of machine learning operations.

In at least one embodiment, untrained neural network 1006 is trained using unsupervised learning, whereas untrained neural network 1006 attempts to train itself using unlabeled data. In at least one embodiment, unsupervised learning training dataset 1002 will include input data without any associated output data or “ground truth” data. In at least one embodiment, untrained neural network 1006 can learn groupings within training dataset 1002 and can determine how individual inputs are related to untrained dataset 1002. In at least one embodiment, unsupervised training can be used to generate a self-organizing map in trained neural network 1008 capable of performing operations useful in reducing dimensionality of new dataset 1012. In at least one embodiment, unsupervised training can also be used to perform anomaly detection, which allows identification of data points in new dataset 1012 that deviate from normal patterns of new dataset 1012.

In at least one embodiment, semi-supervised learning may be used, which is a technique in which in training dataset 1002 includes a mix of labeled and unlabeled data. In at least one embodiment, training framework 1004 may be used to perform incremental learning, such as through transferred learning techniques. In at least one embodiment, incremental learning enables trained neural network 1008 to adapt to new dataset 1012 without forgetting knowledge instilled within trained neural network 1008 during initial training.

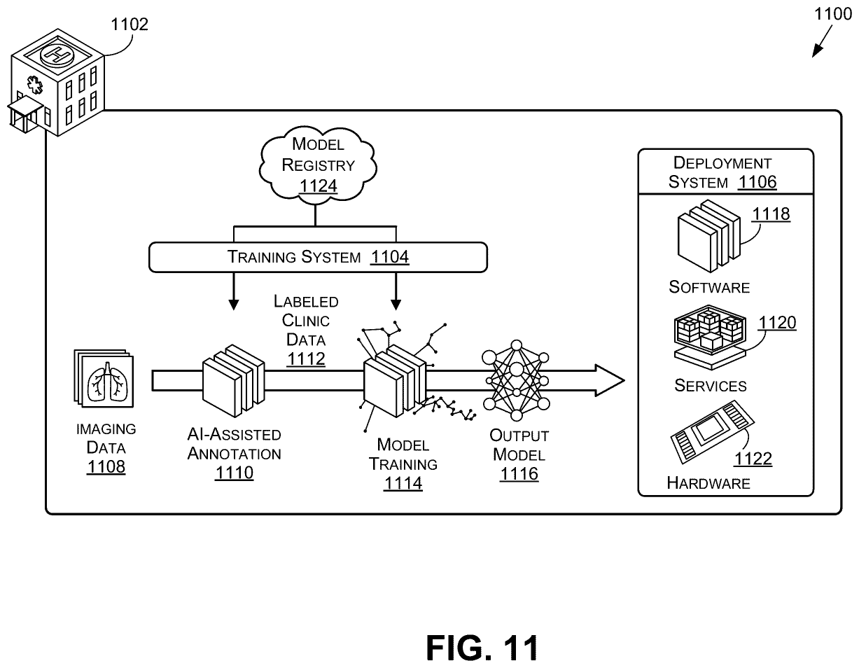

With reference to FIG. 11, FIG. 11 is an example data flow diagram for a process 1100 of generating and deploying a processing and inferencing pipeline, according to at least one embodiment. In at least one embodiment, process 1100 may be deployed to perform game name recognition analysis and inferencing on user feedback data at one or more facilities 1102, such as a data center.

In at least one embodiment, process 1100 may be executed within a training system 1104 and/or a deployment system 1106. In at least one embodiment, training system 1104 may be used to perform training, deployment, and embodiment of machine learning models (e.g., neural networks, object detection algorithms, computer vision algorithms, etc.) for use in deployment system 1106. In at least one embodiment, deployment system 1106 may be configured to offload processing and compute resources among a distributed computing environment to reduce infrastructure requirements at facility 1102. In at least one embodiment, deployment system 1106 may provide a streamlined platform for selecting, customizing, and implementing virtual instruments for use with computing devices at facility 1102. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 1106 during execution of applications.

In at least one embodiment, some applications used in advanced processing and inferencing pipelines may use machine learning models or other AI to perform one or more processing steps. In at least one embodiment, machine learning models may be trained at facility 1102 using feedback data 1108 (such as imaging data) stored at facility 1102 or feedback data 1108 from another facility or facilities, or a combination thereof. In at least one embodiment, training system 1104 may be used to provide applications, services, and/or other resources for generating working, deployable machine learning models for deployment system 1106.

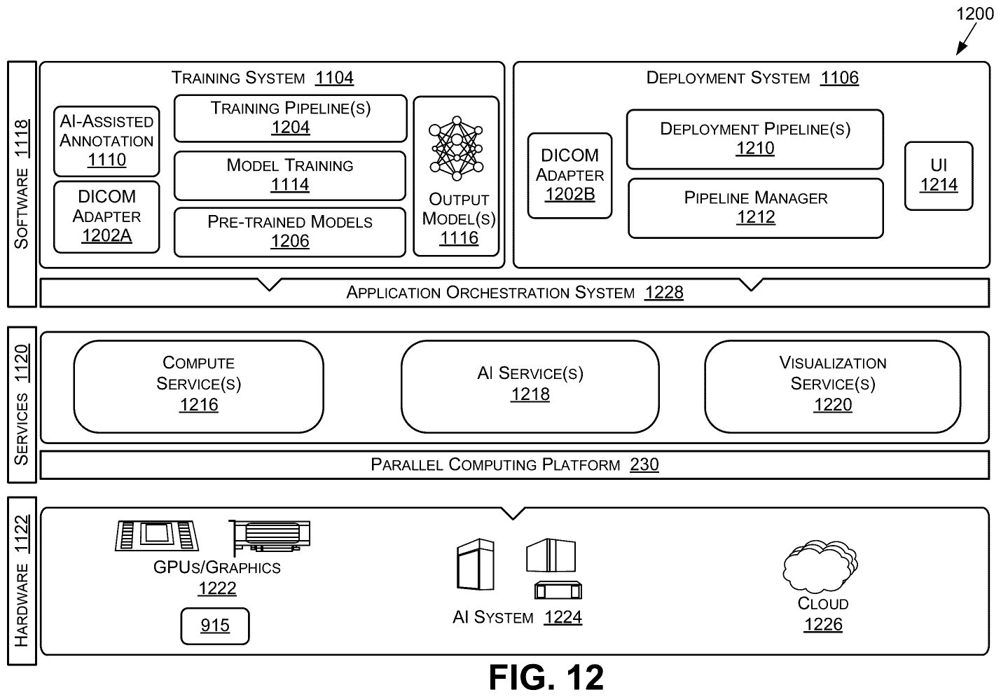

In at least one embodiment, a model registry 1124 may be backed by object storage that may support versioning and object metadata. In at least one embodiment, object storage may be accessible through, for example, a cloud storage (e.g., a cloud 1226 of FIG. 12) compatible application programming interface (API) from within a cloud platform. In at least one embodiment, machine learning models within model registry 1124 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 12) may include a scenario where facility 1102 is training their own machine learning model, or has an existing machine learning model that needs to be optimized or updated. In at least one embodiment, feedback data 1108 may be received from various channels, such as forums, web forms, or the like. In at least one embodiment, once feedback data 1108 is received, AI-assisted annotation 1110 may be used to aid in generating annotations corresponding to feedback data 1108 to be used as ground truth data for a machine learning model. In at least one embodiment, AI-assisted annotation 1110 may include one or more machine learning models (e.g., convolutional neural networks (CNNs)) that may be trained to generate annotations corresponding to certain types of feedback data 1108 (e.g., from certain devices) and/or certain types of anomalies in feedback data 1108. In at least one embodiment, AI-assisted annotations 1110 may then be used directly, or may be adjusted or fine-tuned using an annotation tool, to generate ground truth data. In at least one embodiment, in some examples, labeled data 1112 may be used as ground truth data for training a machine learning model. In at least one embodiment, AI-assisted annotations 1110, labeled data 1112, or a combination thereof may be used as ground truth data for training a machine learning model, e.g., via model training 1114 in FIGS. 9-10. In at least one embodiment, a trained machine learning model may be referred to as an output model 1116, and may be used by deployment system 1106, as described herein.

In at least one embodiment, training pipeline 1004 (FIG. 12) may include a scenario where facility 1102 needs a machine learning model for use in performing one or more processing tasks for one or more applications in deployment system 1106, but facility 1102 may not currently have such a machine learning model (or may not have a model that is optimized, efficient, or effective for such purposes). In at least one embodiment, an existing machine learning model may be selected from model registry 1124. In at least one embodiment, model registry 1124 may include machine learning models trained to perform a variety of different inference tasks on imaging data. In at least one embodiment, machine learning models in model registry 1124 may have been trained on imaging data from different facilities than facility 1102 (e.g., facilities that are remotely located). In at least one embodiment, machine learning models may have been trained on imaging data from one location, two locations, or any number of locations. In at least one embodiment, when being trained on imaging data, which may be a form of feedback data 1108, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 1124. In at least one embodiment, a machine learning model may then be retrained, or updated, at any number of other facilities, and a retrained or updated model may be made available in model registry 1124. In at least one embodiment, a machine learning model may then be selected from model registry 1124—and referred to as output model 1116—and may be used in deployment system 1106 to perform one or more processing tasks for one or more applications of a deployment system.

In at least one embodiment, training pipeline 1004 (FIG. 12) may be used in a scenario that includes facility 1102 requiring a machine learning model for use in performing one or more processing tasks for one or more applications in deployment system 1106, but facility 1102 may not currently have such a machine learning model (or may not have a model that is optimized, efficient, or effective for such purposes). In at least one embodiment, a machine learning model selected from model registry 1124 might not be fine-tuned or optimized for feedback data 1108 generated at facility 1102 because of differences in populations, genetic variations, robustness of training data used to train a machine learning model, diversity in anomalies of training data, and/or other issues with training data. In at least one embodiment, AI-assisted annotation 1110 may be used to aid in generating annotations corresponding to feedback data 1108 to be used as ground truth data for retraining or updating a machine learning model. In at least one embodiment, labeled data 1112 may be used as ground truth data for training a machine learning model. In at least one embodiment, retraining or updating a machine learning model may be referred to as model training 1114. In at least one embodiment, model training 1114—e.g., AI-assisted annotations 1110, labeled data 1112, or a combination thereof—may be used as ground truth data for retraining or updating a machine learning model.

In at least one embodiment, deployment system 1106 may include software 1118, services 1120, hardware 1122, and/or other components, features, and functionality. In at least one embodiment, deployment system 1106 may include a software “stack,” such that software 1118 may be built on top of services 1120 and may use services 1120 to perform some or all of processing tasks, and services 1120 and software 1118 may be built on top of hardware 1122 and use hardware 1122 to execute processing, storage, and/or other compute tasks of deployment system 1106.

In at least one embodiment, software 1118 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 1108 (or other data types, such as those described herein). In at least one embodiment, an advanced processing and inferencing pipeline may be defined based on selections of different containers that are desired or required for processing feedback data 1108, in addition to containers that receive and configure imaging data for use by each container and/or for use by facility 1102 after processing through a pipeline (e.g., to convert outputs back to a usable data type for storage and display at facility 1102). In at least one embodiment, a combination of containers within software 1118 (e.g., that make up a pipeline) may be referred to as a virtual instrument (as described in more detail herein), and a virtual instrument may leverage services 1120 and hardware 1122 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1116 of training system 1104.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1124 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1120 as a system (e.g., system 1200 of FIG. 12). In at least one embodiment, once validated by system 1200 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1200 of FIG. 12). In at least one embodiment, completed and validated applications or containers may be stored in a container registry and associated machine learning models may be stored in model registry 1124. In at least one embodiment, a requesting entity that provides an inference or image processing request may browse a container registry and/or model registry 1124 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 1106 (e.g., a cloud) to perform processing of a data processing pipeline. In at least one embodiment, processing by deployment system 1106 may include referencing selected elements (e.g., applications, containers, models, etc.) from a container registry and/or model registry 1124. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1120 may be leveraged. In at least one embodiment, services 1120 may include compute services, collaborative content creation services, simulation services, artificial intelligence (AI) services, visualization services, and/or other service types. In at least one embodiment, services 1120 may provide functionality that is common to one or more applications in software 1118, so functionality may be abstracted to a service that may be called upon or leveraged by applications. In at least one embodiment, functionality provided by services 1120 may run dynamically and more efficiently, while also scaling well by allowing applications to process data in parallel, e.g., using a parallel computing platform 1230 (FIG. 12). In at least one embodiment, rather than each application that shares a same functionality offered by a service 1120 being required to have a respective instance of service 1120, service 1120 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 1120 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1118 implementing advanced processing and inferencing pipeline may be streamlined because each application may call upon the same inference service to perform one or more inferencing tasks.

In at least one embodiment, hardware 1122 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 1122 may be used to provide efficient, purpose-built support for software 1118 and services 1120 in deployment system 1106. In at least one embodiment, use of GPU processing may be implemented for processing locally (e.g., at facility 1102), within an AI/deep learning system, in a cloud system, and/or in other processing components of deployment system 1106 to improve efficiency, accuracy, and efficacy of game name recognition.

In at least one embodiment, software 1118 and/or services 1120 may be optimized for GPU processing with respect to deep learning, machine learning, and/or high-performance computing, simulation, and visual computing, as non-limiting examples. In at least one embodiment, at least some of the computing environment of deployment system 1106 and/or training system 1104 may be executed in a datacenter or one or more supercomputers or high performance computing systems, with GPU-optimized software (e.g., hardware and software combination of NVIDIA's DGX™ system). In at least one embodiment, hardware 1122 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 12 is a system diagram for an example system 1200 for generating and deploying a deployment pipeline, according to at least one embodiment. In at least one embodiment, system 1200 may be used to implement process 1100 of FIG. 9 and/or other processes including advanced processing and inferencing pipelines. In at least one embodiment, system 1200 may include training system 1104 and deployment system 1106. In at least one embodiment, training system 1104 and deployment system 1106 may be implemented using software 1118, services 1120, and/or hardware 1122, as described herein.

In at least one embodiment, system 1200 (e.g., training system 1104 and/or deployment system 1106) may implemented in a cloud computing environment (e.g., using cloud 1226). In at least one embodiment, system 1200 may be implemented locally with respect to a facility, or as a combination of both cloud and local computing resources. In at least one embodiment, access to APIs in cloud 1226 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1200, may be restricted to a set of public internet service providers (ISPs) that have been vetted or authorized for interaction.

In at least one embodiment, various components of system 1200 may communicate between and among one another using any of a variety of different network types, including but not limited to local area networks (LANs) and/or wide area networks (WANs) via wired and/or wireless communication protocols. In at least one embodiment, communication between facilities and components of system 1200 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 1104 may execute training pipelines 1004, similar to those described herein with respect to FIG. 9. In at least one embodiment, where one or more machine learning models are to be used in deployment pipelines 1210 by deployment system 1106, training pipelines 1004 may be used to train or retrain one or more (e.g., pre-trained) models, and/or implement one or more of pre-trained models 1206 (e.g., without a need for retraining or updating). In at least one embodiment, as a result of training pipelines 1004, output model(s) 1116 may be generated. In at least one embodiment, training pipelines 1004 may include any number of processing steps, AI-assisted annotation 1110, labeling or annotating of feedback data 1108 to generate labeled data 1112, model selection from a model registry, model training 1114, training, retraining, or updating models, and/or other processing steps. In at least one embodiment, for different machine learning models used by deployment system 1106, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 1104 may be used depending on what is required for each respective machine learning model. In at least one embodiment, one or more of machine learning models may already be trained and ready for deployment so machine learning models may not undergo any processing by training system 1104, and may be implemented by deployment system 1106.

In at least one embodiment, output model(s) 1116 and/or pre-trained model(s) 1206 may include any types of machine learning models depending on embodiment. In at least one embodiment, and without limitation, machine learning models used by system 1200 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 1112 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 1108 (or other data type used by machine learning models), there may be corresponding ground truth data generated by training system 1104. In at least one embodiment, AI-assisted annotation may be performed as part of deployment pipelines 1210; either in addition to, or in lieu of, AI-assisted annotation included in training pipelines 1004. In at least one embodiment, system 1200 may include a multi-layer platform that may include a software layer (e.g., software 1118) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 1102. In at least one embodiment, applications may then call or execute one or more services 1120 for performing compute, AI, or visualization tasks associated with respective applications, and software 1118 and/or services 1120 may leverage hardware 1122 to perform processing tasks in an effective and efficient manner.

In at least one embodiment, deployment system 1106 may execute deployment pipelines 1210. In at least one embodiment, deployment pipelines 1210 may include any number of applications that may be sequentially, non-sequentially, or otherwise applied to feedback data (and/or other data types), including AI-assisted annotation, as described above. In at least one embodiment, as described herein, a deployment pipeline 1210 for an individual device may be referred to as a virtual instrument for a device. In at least one embodiment, for a single device, there may be more than one deployment pipeline 1210 depending on information desired from data generated by a device.

In at least one embodiment, applications available for deployment pipelines 1210 may include any application that may be used for performing processing tasks on feedback data or other data from devices. In at least one embodiment, because various applications may share common image operations, in some embodiments, a data augmentation library (e.g., as one of services 1120) may be used to accelerate these operations. In at least one embodiment, to avoid bottlenecks of conventional processing approaches that rely on CPU processing, parallel computing platform 1230 may be used for GPU acceleration of these processing tasks.

In at least one embodiment, deployment system 1106 may include a user interface (UI) 1214 (e.g., a graphical user interface, a web interface, etc.) that may be used to select applications for inclusion in deployment pipeline(s) 1210, arrange applications, modify or change applications or parameters or constructs thereof, use and interact with deployment pipeline(s) 1210 during set-up and/or deployment, and/or to otherwise interact with deployment system 1106. In at least one embodiment, although not illustrated with respect to training system 1104, UI 1214 (or a different user interface) may be used for selecting models for use in deployment system 1106, for selecting models for training, or retraining, in training system 1104, and/or for otherwise interacting with training system 1104. In at least one embodiment, training system 1104 and deployment system 1106 may include DICOM adapters 1202A and 1202B.

In at least one embodiment, pipeline manager 1212 may be used, in addition to an application orchestration system 1028, to manage interaction between applications or containers of deployment pipeline(s) 1210 and services 1120 and/or hardware 1122. In at least one embodiment, pipeline manager 1212 may be configured to facilitate interactions from application to application, from application to service 1120, and/or from application or service to hardware 1122. In at least one embodiment, although illustrated as included in software 1118, this is not intended to be limiting, and in some examples pipeline manager 1212 may be included in services 1120. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1210 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1212 and application orchestration system 1028. In at least one embodiment, so long as an expected input and/or output of each container or application is known by a system (e.g., based on constructs of applications or containers), application orchestration system 1028 and/or pipeline manager 1212 may facilitate communication among and between, and sharing of resources among and between, each of applications or containers. In at least one embodiment, because one or more of applications or containers in deployment pipeline(s) 1210 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1120 leveraged and shared by applications or containers in deployment system 1106 may include compute services 1216, collaborative content creation services 1217, AI services 1218, simulation services 1219, visualization services 1220, and/or other service types. In at least one embodiment, applications may call (e.g., execute) one or more of services 1120 to perform processing operations for an application. In at least one embodiment, compute services 1216 may be leveraged by applications to perform super-computing or other high-performance computing (HPC) tasks. In at least one embodiment, compute service(s) 1216 may be leveraged to perform parallel processing (e.g., using a parallel computing platform 1230) for processing data through one or more of applications and/or one or more tasks of a single application, substantially simultaneously. In at least one embodiment, parallel computing platform 1230 (e.g., NVIDIA's CUDA®) may enable general purpose computing on GPUs (GPGPU) (e.g., GPUs 1222). In at least one embodiment, a software layer of parallel computing platform 1230 may provide access to virtual instruction sets and parallel computational elements of GPUs, for execution of compute kernels. In at least one embodiment, parallel computing platform 1230 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1230 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1218 may be leveraged to perform inferencing services for executing machine learning model(s) associated with applications (e.g., tasked with performing one or more processing tasks of an application). In at least one embodiment, AI services 1218 may leverage AI system 1224 to execute machine learning model(s) (e.g., neural networks, such as CNNs) for segmentation, reconstruction, object detection, feature detection, classification, and/or other inferencing tasks. In at least one embodiment, applications of deployment pipeline(s) 1210 may use one or more of output models 1116 from training system 1104 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 1120 and/or hardware 1122) based on priority paths for different inferencing tasks of AI services 1218.

In at least one embodiment, shared storage may be mounted to AI services 1218 within system 1200. In at least one embodiment, shared storage may operate as a cache (or other storage device type) and may be used to process inference requests from applications. In at least one embodiment, when an inference request is submitted, a request may be received by a set of API instances of deployment system 1106, and one or more instances may be selected (e.g., for best fit, for load balancing, etc.) to process a request. In at least one embodiment, to process a request, a request may be entered into a database, a machine learning model may be located from model registry 1124 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1212) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 1120 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1226, and an inference service may perform inferencing on a GPU.

In at least one embodiment, visualization services 1220 may be leveraged to generate visualizations for viewing outputs of applications and/or deployment pipeline(s) 1210. In at least one embodiment, GPUs 1222 may be leveraged by visualization services 1220 to generate visualizations. In at least one embodiment, rendering effects, such as ray-tracing or other light transport simulation techniques, may be implemented by visualization services 1220 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1220 may include an internal visualizer, cinematics, and/or other rendering or image processing capabilities or functionality (e.g., ray tracing, rasterization, internal optics, etc.).

In at least one embodiment, hardware 1122 may include GPUs 1222, AI system 1224, cloud 1226, and/or any other hardware used for executing training system 1104 and/or deployment system 1106. In at least one embodiment, GPUs 1222 (e.g., NVIDIA's TESLA® and/or QUADRO® GPUs) may include any number of GPUs that may be used for executing processing tasks of compute services 1216, collaborative content creation services 1217, AI services 1218, simulation services 1219, visualization services 1220, other services, and/or any of features or functionality of software 1118. For example, with respect to AI services 1218, GPUs 1222 may be used to perform pre-processing on imaging data (or other data types used by machine learning models), post-processing on outputs of machine learning models, and/or to perform inferencing (e.g., to execute machine learning models). In at least one embodiment, cloud 1226, AI system 1224, and/or other components of system 1200 may use GPUs 1222. In at least one embodiment, cloud 1226 may include a GPU-optimized platform for deep learning tasks. In at least one embodiment, AI system 1224 may use GPUs, and cloud 1226—or at least a portion tasked with deep learning or inferencing—may be executed using one or more AI systems 1224. As such, although hardware 1122 is illustrated as discrete components, this is not intended to be limiting, and any components of hardware 1122 may be combined with, or leveraged by, any other components of hardware 1122.

In at least one embodiment, AI system 1224 may include a purpose-built computing system (e.g., a super-computer or an HPC) configured for inferencing, deep learning, machine learning, and/or other artificial intelligence tasks. In at least one embodiment, AI system 1224 (e.g., NVIDIA's DGX™) may include GPU-optimized software (e.g., a software stack) that may be executed using a plurality of GPUs 1222, in addition to CPUs, RAM, storage, and/or other components, features, or functionality. In at least one embodiment, one or more AI systems 1224 may be implemented in cloud 1226 (e.g., in a data center) for performing some or all of AI-based processing tasks of system 1200.

In at least one embodiment, cloud 1226 may include a GPU-accelerated infrastructure (e.g., NVIDIA's NGC™) that may provide a GPU-optimized platform for executing processing tasks of system 1200. In at least one embodiment, cloud 1226 may include an AI system(s) 1224 for performing one or more of AI-based tasks of system 1200 (e.g., as a hardware abstraction and scaling platform). In at least one embodiment, cloud 1226 may integrate with application orchestration system 1028 leveraging multiple GPUs to enable seamless scaling and load balancing between and among applications and services 1120. In at least one embodiment, cloud 1226 may be tasked with executing at least some of services 1120 of system 1200, including compute services 1216, AI services 1218, and/or visualization services 1220, as described herein. In at least one embodiment, cloud 1226 may perform small and large batch inference (e.g., executing NVIDIA's TensorRT™), provide an accelerated parallel computing API and platform 1230 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1200.

In at least one embodiment, in an effort to preserve patient confidentiality (e.g., where patient data or records are to be used off-premises), cloud 1226 may include a registry, such as a deep learning container registry. In at least one embodiment, a registry may store containers for instantiations of applications that may perform pre-processing, post-processing, or other processing tasks on patient data. In at least one embodiment, cloud 1226 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

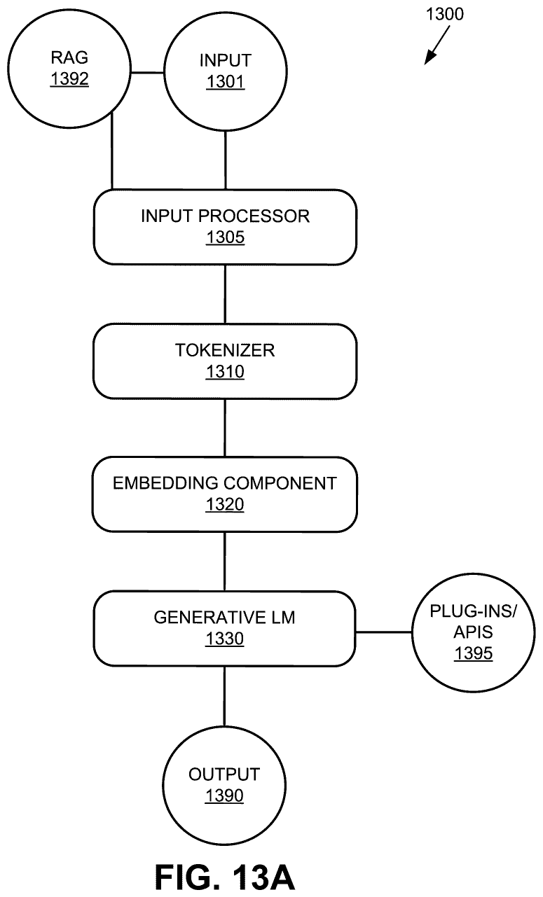

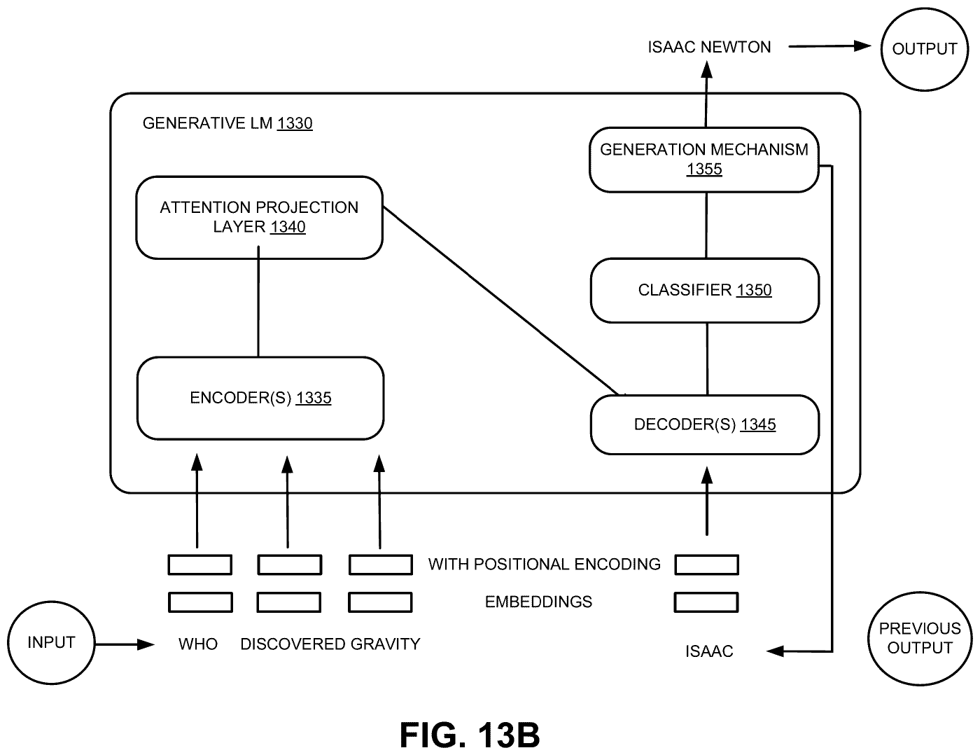

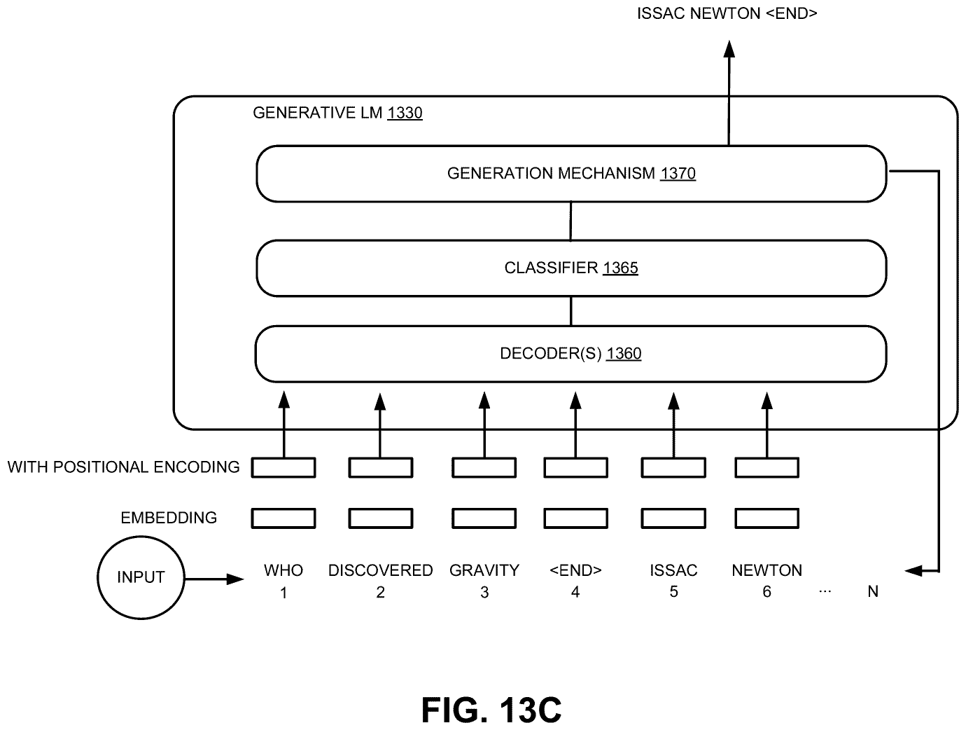

FIG. 13A is a block diagram of an example generative language model system 1300 suitable for use in implementing at least some embodiments of the present disclosure. In the example illustrated in FIG. 13A, the generative language model system 1300 includes a retrieval augmented generation (RAG) component 1392, an input processor 1305, a tokenizer 1310, an embedding component 1320, plug-ins/APIs 1395, and a generative language model (LM) 1330 (which may include an LLM, a SLM, a VLM, a multi-modal LM, etc.).

At a high level, the input processor 1305 may receive an input 1301 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1330 (e.g., LLM/SLMs/VLM/MMLM/etc.). In some embodiments, the input 1301 includes plain text in the form of one or more sentences, paragraphs, and/or documents. Additionally or alternatively, the input 1301 may include numerical sequences, precomputed embeddings (e.g., word or sentence embeddings), and/or structured data (e.g., in tabular formats, JSON, or XML). In some implementations in which the generative LM 1330 is capable of processing multi-modal inputs, the input 1301 may combine text (or may omit text) with image data, audio data, video data, design data, USD data, and/or other types of input data, such as but not limited to those described herein. Taking raw input text as an example, the input processor 1305 may prepare raw input text in various ways. For example, the input processor 1305 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1305 may remove stopwords to reduce noise and focus the generative LM 1330 on more meaningful content. The input processor 1305 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1392 (which may include one or more RAG models, and/or may be performed using the generative LM 1330 itself) may be used to retrieve additional information to be used as part of the input 1301 or prompt. RAG may be used to enhance the input to the LLM/SLMs/VLM/MMLM/etc. with external knowledge, so that answers to specific questions or queries or requests are more relevant—such as in a case where specific knowledge is required. The RAG component 1392 may fetch this additional information (e.g., grounding information, such as grounding text/image/video/audio/USD/CAD/etc.) from one or more external sources, which can then be fed to the LLM/SLMs/VLM/MMLM/etc. along with the prompt to improve accuracy of the responses or outputs of the model.

For example, in some embodiments, the input 1301 may be generated using the query or input to the model (e.g., a question, a request, etc.) in addition to data retrieved using the RAG component 1392. In some embodiments, the input processor 1305 may analyze the input 1301 and communicate with the RAG component 1392 (or the RAG component 1392 may be part of the input processor 1305, in embodiments) in order to identify relevant text and/or other data to provide to the generative LM 1330 as additional context or sources of information from which to identify the response, answer, or output 1190, generally. For example, where the input indicates that the user is interested in a desired tire pressure for a particular make and model of vehicle, the RAG component 1392 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1392 may retrieve a prior stored conversation history—or at least a summary thereof—and include the prior conversation history along with the current ask/request as part of the input 1301 to the generative LM 1330.

The RAG component 1392 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1392 and the embeddings of the chunks along with the embeddings of the query may be compared to identify the most similar/related embeddings to the query, which may be supplied to the generative LM 1330 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLMs/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLMs/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLMs/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1392 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1310 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1330 to understand morphological variations and handle out-of-vocabulary words more effectively. Character-based tokenization represents each character as a separate token, enabling the generative LM 1330 to process text at a fine-grained level. The choice of tokenization strategy may depend on factors such as the language being processed, the task at hand, and/or characteristics of the training dataset. As such, the tokenizer 1310 may convert the (e.g., processed) text into a structured format according to tokenization schema being implemented in the particular embodiment.

The embedding component 1320 may use any known embedding technique to transform discrete tokens into (e.g., dense, continuous vector) representations of semantic meaning. For example, the embedding component 1320 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1301 includes image data/video data/etc., the input processor 1301 may resize the data to a standard size compatible with format of a corresponding input channel and/or may normalize pixel values to a common range (e.g., 0 to 1) to ensure a consistent representation, and the embedding component 1320 may encode the image data using any known technique (e.g., using one or more convolutional neural networks (CNNs) to extract visual features). In some implementations in which the input 1301 includes audio data, the input processor 1301 may resample an audio file to a consistent sampling rate for uniform processing, and the embedding component 1320 may use any known technique to extract and encode audio features—such as in the form of a spectrogram (e.g., a mel-spectrogram). In some implementations in which the input 1301 includes video data, the input processor 1301 may extract frames or apply resizing to extracted frames, and the embedding component 1320 may extract features such as optical flow embeddings or video embeddings and/or may encode temporal information or sequences of frames. In some implementations in which the input 1301 includes multi-modal data, the embedding component 1320 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1330 and/or other components of the generative LM system 1300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1320 may apply an encoded representation of the input 1301 to the generative LM 1330, and the generative LM 1330 may process the encoded representation of the input 1301 to generate an output 1190, which may include responsive text and/or other types of data.

As described herein, in some embodiments, the generative LM 1330 may be configured to access or use—or capable of accessing or using—plug-ins/APIs 1395 (which may include one or more plug-ins, application programming interfaces (APIs), databases, data stores, repositories, etc.). For example, for certain tasks or operations that the generative LM 1330 is not ideally suited for, the model may have instructions (e.g., as a result of training, and/or based on instructions in a given prompt, such as those retrieved using the RAG component 1392) to access one or more plug-ins/APIs 1395 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1395 to the plug-in/API 1395, the plug-in/API 1395 may process the information and return an answer to the generative LM 1330, and the generative LM 1330 may use the response to generate the output 1190. This process may be repeated—e.g., recursively—for any number of iterations and using any number of plug-ins/APIs 1395 until an output 1190 that addresses each ask/question/request/process/operation/etc. from the input 1301 can be generated. As such, the model(s) may not only rely on its own knowledge from training on a large dataset(s) and/or from data retrieved using the RAG component 1392, but also on the expertise or optimized nature of one or more external resources—such as the plug-ins/APIs 1395.

FIG. 13B is a block diagram of an example implementation in which the generative LM 1330 includes a transformer encoder-decoder. For example, assume input text such as “Who discovered gravity” is tokenized (e.g., by the tokenizer 1310 of FIG. 13A) into tokens such as words, and each token is encoded (e.g., by the embedding component 1320 of FIG. 13A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1335 of the generative LM 1330.

In an example implementation, the encoder(s) 1335 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1340 may convert the context vector into attention vectors (keys and values) for the decoder(s) 1345.

In an example implementation, the decoder(s) 1345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1335, in an example transformer architecture, each token (e.g., word) flows through a separate path in the decoder(s) 1345. During a first pass, the decoder(s) 1345, a classifier 1350, and a generation mechanism 1355 may generate a first token, and the generation mechanism 1355 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1335, except that it creates its queries from the layer below it and takes the keys and values (e.g., matrix) from the output of the encoder(s) 1335.

As such, the decoder(s) 1345 may output some decoded (e.g., vector) representation of the input being applied during a particular pass. The classifier 1350 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1355 may select or sample a word or token based on a corresponding predicted probability (e.g., select the word with the highest predicted probability) and append it to the output from a previous pass, generating each word or token sequentially. The generation mechanism 1355 may repeat the process, triggering successive decoder inputs and corresponding predictions until selecting or sampling a symbol or token that represents the end of the response, at which point, the generation mechanism 1355 may output the generated response.

FIG. 13C is a block diagram of an example implementation in which the generative LM 1330 includes a decoder-only transformer architecture. For example, the decoder(s) 1360 of FIG. 13C may operate similarly as the decoder(s) 1345 of FIG. 13B except each of the decoder(s) 1360 of FIG. 13C omits the encoder-decoder self-attention layer (since there is no encoder in this implementation). As such, the decoder(s) 1360 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1360. As with the decoder(s) 1345 of FIG. 13B, each token (e.g., word) may flow through a separate path in the decoder(s) 1360, and the decoder(s) 1360, a classifier 1365, and a generation mechanism 1370 may use auto-regression to sequentially generate one token at a time until predicting a symbol or token that represents the end of the response. The classifier 1365 and the generation mechanism 1370 may operate similarly as the classifier 1350 and the generation mechanism 1355 of FIG. 13B, with the generation mechanism 1370 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

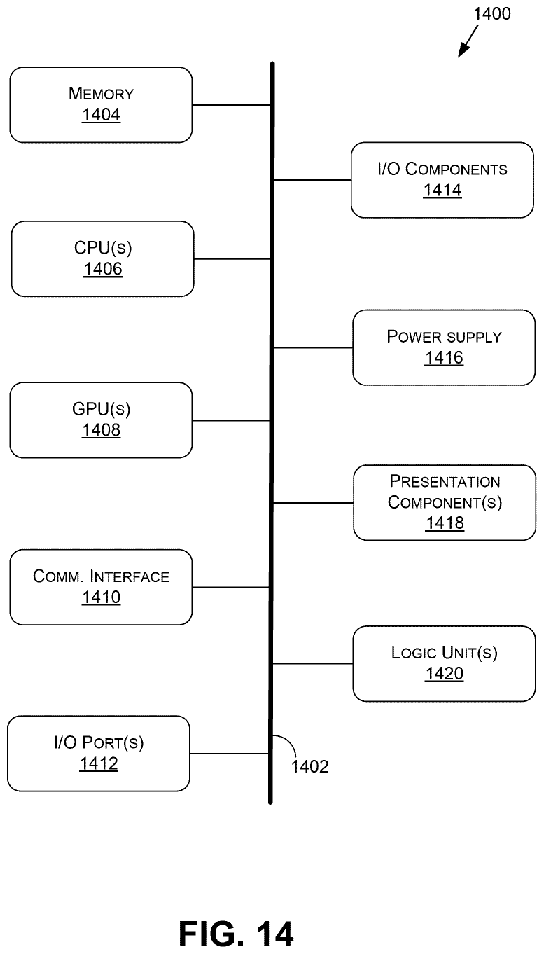

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). As such, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that allow the computing device 1400 to communicate with other computing devices via an electronic communication network, included wired and/or wireless communications. The communication interface 1410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may allow the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that allow detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to allow the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing computing device (“CPU”) executes some of instructions while a graphics processing computing device (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computing system comprising:
a memory; and
one or more processors, coupled to the memory, to:
determine, based on an indicator associated with a first node of a plurality of nodes, that the first node assigned to a first phase of a task is in a first state of a plurality of states;
cause a first identifier of the first node to be added to a first queue of a plurality of queues, the first queue being associated with the first state;
determine, for a second phase of the task, a second identifier of a second node of the plurality of nodes using a second queue of the plurality of queues, the second queue being associated with a second state of the plurality of states; and
provide the first identifier and the second identifier to a scheduler to advance the task to the second phase.

2. The computing system of claim 1, wherein the first state is an execution state and the second state is a ready state.

3. The computing system of claim 1, wherein the one or more processors are further to:
cause removal of the first identifier from the first queue; and
cause addition of the second identifier to the first queue.

4. The computing system of claim 3, wherein to cause the removal of the first identifier from the first queue, the one or more processors are further to:
check a scheduling condition for the first identifier;
identify a third queue of the plurality of queues associated with the scheduling condition; and
cause addition of the first identifier to the third queue.

5. The computing system of claim 4, wherein the one or more processors are further to:
based on satisfaction of the scheduling condition, cause removal of the first identifier from the third queue; and
cause addition of the first identifier to the second queue.

6. The computing system of claim 1, wherein the plurality of queues is stored on a data storage communicatively coupled with the scheduler.

7. The computing system of claim 1, wherein the plurality of nodes and the scheduler are communicatively coupled to an external source.

8. A method comprising:
determining that a first node of a plurality of nodes assigned to a first phase of a task is in a first state of a plurality of states;
causing a first identifier of the first node to be added to a first queue of a plurality of queues, the first queue being associated with the first state;
determining, for a second phase of the task, a second identifier of a second node of the plurality of nodes using a second queue of the plurality of queues, the second queue being associated with a second state of the plurality of states; and
providing the first identifier and the second identifier to a scheduler to advance the task to the second phase.

9. The method of claim 8, wherein the first state is an execution state and the second state is a ready state.

10. The method of claim 8, further comprising:
causing removal of the first identifier from the first queue; and
causing addition of the second identifier to the first queue.

11. The method of claim 10, wherein causing the removal of the first identifier from the first queue comprises:
checking a scheduling condition for the first identifier;
identifying a third queue of the plurality of queues associated with the scheduling condition; and
causing addition of the first identifier to the third queue.

12. The method of claim 11, further comprising:
based on satisfaction of the scheduling condition, causing removal of the first identifier from the third queue; and
causing addition of the first identifier to the second queue.

13. The method of claim 8, wherein the plurality of queues is stored on a data storage communicatively coupled with the scheduler.

14. The method of claim 8, wherein the plurality of nodes and the scheduler are communicatively coupled to an external source.

15. One or more processors comprising:
processing circuitry to:
determine that a first node of a plurality of nodes assigned to a first phase of a task is in a first state of a plurality of states;
cause a first identifier of the first node to be added to a first queue of a plurality of queues;
determine, for a second phase of the task, a second identifier of a second node of the plurality of nodes using a second queue of the plurality of queues; and
cause the task to advance to the second phase using the first identifier and the second identifier.

16. The one or more processors of claim 15, wherein the first state is an execution state and the second state is a ready state.

17. The one or more processors of claim 15, wherein the processing circuitry is further to:
cause removal of the first identifier from the first queue; and
cause addition of the second identifier to the first queue.

18. The one or more processors of claim 17, wherein to cause the removal of the first identifier from the first queue, the processing circuitry is further to:
check a scheduling condition for the first identifier;
identify a third queue of the plurality of queues associated with the scheduling condition; and
cause addition of the first identifier to the third queue.

19. The one or more processors of claim 18, wherein the processing circuitry is further to:
based on satisfaction of the scheduling condition, cause removal of the first identifier from the third queue; and
cause addition of the first identifier to the second queue.

20. The one or more processors of claim 15, wherein the plurality of queues is stored on a data storage communicatively coupled with a scheduler.
